(19) United States
(12) Patent Application Publication
(10) Pub. No.: US 2013/0220511 A1
(43) Pub. Date: Aug. 29, 2013

(54) METHOD FOR MANUFACTURING AN IMAGE DISPLAY DEVICE

(71) Applicants: Shunsuke Suzuki, Tama-ku (JP); Hikaru Takeda, Hachioji-shi (JP); Nami Kobori, Yokohama-shi (JP); Sotaro Endo, Hachioji-shi (JP)

(72) Inventors: Shunsuke Suzuki, Tama-ku (JP); Hikaru Takeda, Hachioji-shi (JP); Nami Kobori, Yokohama-shi (JP); Sotaro Endo, Hachioji-shi (JP)

(73) Assignee: 3M INNOVATIVE PROPERTIES COMPANY, ST. PAUL, MN (US)

(21) Appl. No.: 13/819,626

(22) PCT Filed: Aug. 11, 2011
(86) PCT No.: PCT/US11/47338

§ 371 Date: May 9, 2013

(30) Foreign Application Priority Data
Sep. 1, 2010 (JP) 2010-195970

(51) Int. Cl. B32B 37/12

(52) U.S. Cl. CPC B32B 37/12
USPC 156/60

(57) ABSTRACT

The present invention provides a method of manufacturing an image display device. The method includes providing a translucent sheet, a pressure-sensitive adhesive sheet, an image display unit and a liquid adhesive. The translucent sheet has a first principal surface, a second principal surface opposite the first principal surface, a first edge part and a second edge part opposite the first edge part. The pressure-sensitive adhesive sheet has a first principal surface and a second principal surface opposite the first principal surface. The image display unit has a display surface. The method further includes laminating the first principal surface of the pressure-sensitive adhesive sheet to the first principal surface of the translucent sheet; applying the liquid adhesive to at least a part of at least one of the second principal surface of the pressure-sensitive adhesive sheet and the display surface of the image display unit; opposing the first principal surface of the translucent sheet to the display surface of the image display unit; and curing the liquid adhesive remaining between the second principal surface of the pressure-sensitive adhesive sheet laminated to the translucent sheet and the display surface of the image display unit. Opposing the first principal surface of the translucent sheet to the display surface of the image display unit includes, first, putting the first edge part of the translucent sheet close to the display surface of the image display unit until a portion of the pressure-sensitive adhesive sheet laminated to the translucent sheet in the vicinity of the first edge part of the translucent sheet comes into contact with the display surface of the image display unit, and second, putting the second edge part of the translucent sheet close to the display surface of the image display unit while flowing the liquid adhesive in the direction of the second edge part from the first edge part of the translucent sheet, and thereby laminating the second principal surface of the pressure-sensitive adhesive sheet laminated with the translucent sheet to the display surface of the image display unit.

### TECHNICAL FIELD

The present disclosure relates generally to a method for manufacturing an image display device.

### BACKGROUND

The display surface of an image display device, such as a liquid crystal display (LCD) or an organic EL display, is generally protected with a translucent sheet, such as a glass plate or plastic plate. The translucent sheet is fixed to the housing of an image display device, for example, by laminating a tape or coating an adhesive along the edge of the translucent sheet. This procedure creates a gap between the transluscent sheet and housing which is typically filled with air. Therefore, an air layer is present between the translucent sheet and the display surface of the image display device. For example, in the case of a liquid crystal image device, because of the difference in refractive indexes between the air layer and the translucent sheet and the difference in refractive indexes between the air layer and the liquid crystal module material, reflection or scattering of light is caused, and this may bring about reduction in the luminance or contrast of an image displayed on the image display device and in turn, impairment of visibility of the image. Accordingly, in recent years, a transparent substance having a refractive index close to the refractive indexes of the translucent sheet and the liquid crystal module material as compared to air, is filled in the gap between the display surface of the image display device and the translucent sheet, whereby visibility of the image displayed on the image display device is enhanced.

Kokai (Japanese Unexamined Patent Publication) No. 2004-188953 describes a production method of a functional transparent panel, comprising laminating a functional transparent film to a transparent panel via a sticking agent whose viscosity at the lamination is from 10 to 1,000 cP, applying an external force having a component perpendicular to the lamination surfaces of the transparent panel and the functional transparent film, thereby fluidizing the sticking agent to make the thickness of the sticking agent coated uniform, then curing the sticking agent to stick the functional transparent film to the transparent panel.

Japanese Patent No. 3676478 describes a production method of a liquid crystal display device, comprising tightly contacting the viewing side of a liquid crystal display panel and a transparent protective plate through a transparent resin sheet composed of a plasticizer-containing acrylic polymer in the state of a volatile liquid incapable of swelling or dissolving the sheet and having viscosity of 10 cp or less being deployed either between the transparent resin sheet and the liquid crystal display panel or between the transparent resin sheet and the transparent protective plate or both, and subjecting them to a drying treatment under heat and pressure.

Kokai No. 2002-55330 describes a method for manufacturing a laminate sheet for liquid crystal panels, comprising adhering an adhesive sheet for liquid crystal display panels, which comprises a backing resin sheet, a UV-curable pressure-sensitive adhesive layer A formed on one surface of the backing resin sheet, and a pressure-sensitive adhesive layer B formed on another surface and containing an acrylic pressure-sensitive adhesive and an ultraviolet crosslinking compound and which is configured to firmly adhere to a translucent plastic film for liquid crystal display panels placed on the pressure-sensitive adhesive layer A, as well as to a substrate for fixing disposed below the pressure-sensitive adhesive layer B and thereby make their integration before ultraviolet irradiation but be reduced only in the adhesive force to the translucent plastic film after ultraviolet irradiation so as to enable easy separation of the translucent plastic film from the substrate and the adhesive sheet for liquid crystal display panels, to the substrate through the pressure-sensitive adhesive layer B and at the same time, to the translucent plastic film through the pressure-sensitive adhesive layer A.

PCT International Publication No. WO 2007/063751 describes a production method of a display device in which a polygonal transparent body and a display element are adhered by means of a transparent adhesive, the production method comprising a step of coating a fixed amount of a liquid adhesive like dots in a plurality of portions on the adhesion surface of the transparent body or on the adhesion surface of the display element, a step of coating an adhesive linearly to connect the plurality of liquid adhesives coated like dots, a step of turning over the transparent body or display element coated with the liquid adhesive, a step of forming drips of the liquid adhesive coated like dots, a step of contacting the liquid adhesive with an opposed adherend while imposing no impact on the drips, and a step of curing the liquid adhesive.

Kokai No. 2004-296139 describes a production method of a display device, comprising a step of forming a display element on a first substrate, a step of disposing a resin material on the display element side of the first substrate, a step of linearly contacting the center part of a second substrate with the resin material disposed on the first substrate, and a step of applying force in the directions opposite to each other toward each of opposed two sides from the center part of the second substrate, thereby adhering together the second substrate and the first substrate through the resin material.

### SUMMARY

An object of the present disclosure is to reduce air bubbles and to minimize the variation of distance between the display surface of an image display device and a translucent sheet. More specifically, an object of the present disclosure is to reduce air bubbles present between the display surface of an image display device and a translucent sheet when the distance between the image display device and the translucent sheet is from about 25 to 300 μm and at the same time, when a step part with a height corresponding to about 15% or more of the distance between the image display device and the translucent sheet is present on the display surface of the image display device and/or when the pressure-sensitive adhesive sheet has a variation in the thickness. Another object of the present disclosure is to easily adhere together a hard translucent sheet and the hard display surface of an image display device without entraining an air bubble.

In one embodiment, the present invention is a method of manufacturing an image display device. The method includes providing a translucent sheet, a pressure-sensitive adhesive sheet, an image display unit and a liquid adhesive. The translucent sheet has a first principal surface, a second principal surface opposite the first principal surface, a first edge part and a second edge part opposite the first edge part. The pressure-sensitive adhesive sheet has a first principal surface and a second principal surface opposite the first principal surface. The image display unit has a display surface. The method further includes laminating the first principal surface of the pressure-sensitive adhesive sheet to the first principal surface of the translucent sheet; applying the liquid adhesive to at least a part of at least one of the second principal surface of the pressure-sensitive adhesive sheet and the display surface of the image display unit; opposing the first principal surface of the translucent sheet to the display surface of the image display unit; and curing the liquid adhesive remaining between the second principal surface of the pressure-sensitive adhesive sheet laminated to the translucent sheet and the display surface of the image display unit. Opposing the first principal surface of the translucent sheet to the display surface of the image display unit includes, first, putting the first edge part of the translucent sheet close to the display surface of the image display unit until a portion of the pressure-sensitive adhesive sheet laminated to the translucent sheet in the vicinity of the first edge part of the translucent sheet comes into contact with the display surface of the image display unit, and second, putting the second edge part of the translucent sheet close to the display surface of the image display unit while flowing the liquid adhesive in the direction of the second edge part from the first edge part of the translucent sheet, and thereby laminating the second principal surface of the pressure-sensitive adhesive sheet laminated with the translucent sheet to the display surface of the image display unit.

### BRIEF DESCRIPTION OF THE DRAWINGS

FIG. 1 is a cross-sectional view of an image display device manufactured by a method of manufacturing an image display device according to one embodiment of the present disclosure.

FIGS. 2a-2c illustrates a method of manufacturing an image display device according to one embodiment of the present disclosure.

FIGS. 3a and 3b illustrates a method of manufacturing an image display device according to one embodiment of the present disclosure.

FIGS. 4a and 4b illustrates a method of manufacturing an image display device according to one embodiment of the present disclosure.

FIG. 5 illustrates a method of manufacturing an image display device according to one embodiment of the present disclosure.

FIGS. 6a and 6b illustrates a step of applying a liquid adhesive as another aspect of the method of manufacturing an image display device according to one embodiment of the present disclosure.

FIG. 7 illustrates a step of applying a liquid adhesive as another aspect of the method of manufacturing an image display device according to one embodiment of the present disclosure.

FIG. 8 is a cross-sectional view of an image display device manufactured by the method of manufacturing an image display device according to one embodiment of the present disclosure.

FIGS. 9a and 9b illustrates a method of manufacturing an image display device according to one embodiment of the present disclosure.

FIG. 10 is a schematic view of a manufacturing apparatus of an image display device according to one embodiment of the present disclosure.

FIGS. 11a-11c illustrates a method of manufacturing an image display device when using a manufacturing apparatus of an image display device according to one embodiment of the present disclosure.

FIGS. 12a-12c illustrates a method of manufacturing an image display device when using a manufacturing apparatus of an image display device according to one embodiment of the present disclosure.

FIGS. 13a-13c illustrates a method of manufacturing an image display device when using a manufacturing apparatus of an image display device according to one embodiment of the present disclosure.

FIGS. 14a-14d illustrates a method of manufacturing an image display device when using a manufacturing apparatus of an image display device according to one embodiment of the present disclosure.

FIGS. 15a and 15b illustrates a method of manufacturing an image display device when using a manufacturing apparatus of an image display device according to one embodiment of the present disclosure.

### DETAILED DESCRIPTION

One embodiment of the present disclosure is described below by referring to the drawings, but the present disclosure is not limited to the following embodiment.

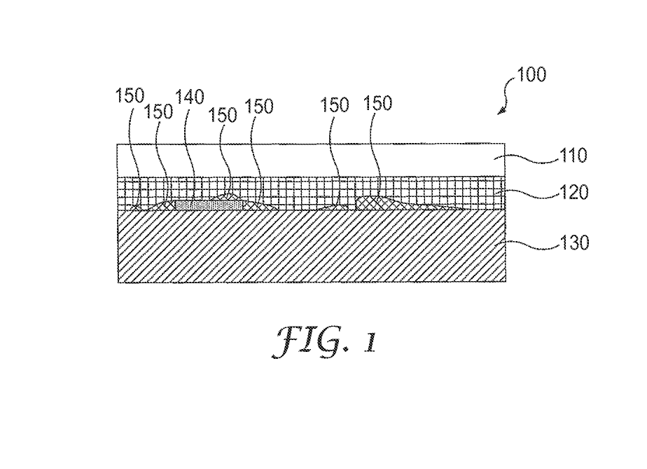

FIG. 1 is a cross-sectional view of an image display device manufactured by a method of manufacturing an image display device according to one embodiment of the present disclosure. The image display device 100 comprises a translucent sheet 110 and an image display unit 130. On the display surface of the image display unit 130, a step part 140 (height: from 500 nm to 200 microns) such as a printed transparent electrode (height: 500 nm), 3D display lens, or a step part (height: several tens of microns) due to an ink printed for decoration is disposed. A pressure-sensitive adhesive sheet 120 is disposed between the translucent sheet 110 and the image display unit 130, and a cured adhesive 150 fils in the gap between the pressure-sensitive adhesive sheet 120 and the image display unit 130.

The translucent sheet 110 is a plastic backing having translucency, such as an acrylic resin (e.g., polymethyl methacrylate (PMMA)), polyolefin (e.g., polypropylene, polyethylene), polyester, polycarbonate resin and silicone resin, or a glass backing having translucency. The translucent sheet 110 is, for example, a protective layer of the display surface of the image display unit 130. The translucent sheet 110 may also be a composite backing obtained by combining the above-described plastic backing or glass backing with another material. Examples of the composite backing include a touch panel substrate. A step part due to an ink for decoration or a step part formed by pattern printing of a transparent electrode or the like may be formed also on the surface of the translucent sheet 110.

The image display unit 130 is a device for converting electric signals into optical information. Examples of the image display unit 130 include, but are not limited to: a reflective or backlight-type liquid crystal display unit, a plasma display unit, an electroluminescence (EL) display unit and an electron paper display unit. For example, in the backlight-type liquid crystal display unit, although not shown, a reflector, a backlight source, a light-diffusing film, a luminance-enhancing film and a liquid crystal display panel are sequentially disposed.

The pressure-sensitive adhesive sheet 120 is a sheet-shaped pressure-sensitive adhesive having translucency. The thickness of the pressure-sensitive adhesive sheet is particularly from about 10 μm to about 2,000 μm. The thickness of the pressure-sensitive adhesive sheet is more particularly from about 25 μm to about 300 μm. Also, the maximum thickness of the pressure-sensitive adhesive sheet 120 is particularly equal to the desired distance between the translucent sheet 110 and the image display unit 130.

In one embodiment, the total light transmittance in the visible light region of the pressure-sensitive adhesive sheet 120 is, for example, about 80% or more and the haze of the pressure-sensitive adhesive sheet 120 when employing a D65 light source is, for example, about 2% or less. Examples of the pressure-sensitive adhesive sheet 120 include, but are not limited to, an acrylic pressure-sensitive adhesive sheet such as: a copolymer of isooctyl acrylate and acrylic acid, a synthetic rubber-based pressure-sensitive adhesive sheet such as silicone, polyisoprene, polybutadiene and styrene-isoprene-styrene copolymer, a natural rubber-based pressure-sensitive adhesive sheet, and a hot melt-type pressure-sensitive adhesive sheet. Among these, an acrylic pressure-sensitive adhesive sheet is particularly suitable as the pressure-sensitive adhesive sheet 120.

In the case of an acrylic pressure-sensitive adhesive sheet, the pressure-sensitive adhesive sheet 120 is preferably a copolymerized polymer having a weight average molecular weight Mw of about 300,000 or more obtained by polymerizing about 50% or more of an acryl monomer and/or oligomer and/or a modified product thereof.

Examples of the acryl monomer and oligomer include, but are not limited to: methyl acrylate, ethyl acrylate, n-butyl acrylate, isobutyl acrylate, isoamyl acrylate, 2-ethylhexyl (meth)acrylate, isooctyl (meth)acrylate, dodecyl (meth)acrylate, acrylic aid, methacrylic acid, maleic acid, itaconic acid, ω-carboxypolycaprolactone mono(meth)acrylate, monohydroxyethyl phthalate (meth)acrylate, β-carboxyethyl (meth)acrylate, 2-(meth)acryloyloxyethylsuccinic acid, 2-(meth)acryloyloxyethylhexahydrophthalic acid, isobornyl acrylate, a hydroxyl group-containing acrylate such as 2-hydroxyethyl (meth)acrylate, and 2-(2-ethoxyethoxy)ethyl (meth)acrylate. The later-described liquid adhesive may also be produced using such an acrylic monomer or oligomer.

The pressure-sensitive adhesive sheet 120 is formed of a viscoelastic body and can be compressed in volume when adhered together with the later-described step part 140. The compression ratio of the pressure-sensitive adhesive sheet 120 is particularly 15% or more in the thickness direction. In the case where the side surface of the step part 140 is gently sloped, the pressure-sensitive adhesive sheet 120 can be gaplessly adhered together to the image display unit 130 only by the pressure-sensitive adhesive sheet 120. However, depending on the shape of the step part 140, even when the pressure-sensitive sheet 120 is deformed, a gap sometimes occurs between the pressure-sensitive adhesive sheet 120 and the step part 140.

The adhesive force of the pressure-sensitive adhesive sheet 120 is particularly about 1 N/25 mm or more. This adhesive force is a value measured in accordance with JIS Z-0237:2000. That is, a pressure-sensitive adhesive sheet of 25 mm in width, whose one surface is laminated with a 25 μm-thick PET film (S, produced by Unitika Ltd.), is laminated to a BA-SUS plate while pressure-bonding it by using a roller having a weight of 2 kg and moving at a rate of 300 mm/min. After standing for 30 minutes, the pressure-sensitive adhesive sheet is peeled off from the BA-SUS plate at a peeling rate of 300 mm/min and a peeling angle of 180°, whereby the adhesive force is measured. The adhesive force of the pressure-sensitive adhesive sheet 120 to the later-described cured adhesive is also preferably about 1 N/25 mm or more.

Examples of the step part 140 include a transparent electrode such as ITO (indium tin oxide) disposed on the display surface of the image display unit 130, a 3D display lens, and a printed part printed for decoration. The height of the step part 140 with respect to the display surface of the image display unit 130 may be, for example, about 0.5 μm, 3 μm, 5 μm or more. The height of the step part 140 with respect to the display surface of the image display unit 130 may be, for example, about 200 μm, 150 μm, 100 μm or less. Also, in the case where the thickness of the pressure-sensitive adhesive sheet 120 is from about 25 to about 300 μm, the height of the step part 140 is particularly, for example, about 15% or more of the thickness of the pressure-sensitive adhesive sheet 120. It is difficult to adjust the thickness of the cured liquid adhesive to be greater than about 25 μm. Furthermore, the translucent sheet and the image display unit are difficult to adhere together without producing a gap around the step part 140 having a height of about 15% or more of the thickness of the pressure-sensitive adhesive sheet by using only a pressure-sensitive adhesive sheet of about 300 μm or less in thickness. Accordingly, when the thickness of the pressure-sensitive adhesive sheet is from about 25 μm to about 300 μm and at the same time, the height of the step part is about 15% or more of the thickness of the pressure-sensitive adhesive sheet, the benefit of the manufacturing method of an image display device in one embodiment of the present disclosure is particularly significant.

The cured adhesive 150 is a material obtained by curing a liquid adhesive under irradiation of ultraviolet ray or visible light or under heating. In one embodiment, the total light transmittance in the visible light region of the cured adhesive 150 is, for example, about 80% or more and the haze of the cured adhesive 150 when employing a D65 light source is, for example, about 2% or less. Details of the cured adhesive and the liquid adhesive are described later.

The adhesive force between the cured product of a liquid adhesive and the pressure-sensitive adhesive sheet is also particularly about 1 N/25 mm or more. This adhesive force can also be measured in accordance with JIS Z-0237:2000. That is, in the method above, for example, a liquid adhesive coated to a thickness of 25 μm on a BA-SUS plate is prepared in place of the BA-SUS plate and thoroughly cured by ultraviolet irradiation or the like, and a pressure-sensitive adhesive sheet (with a PET film having a width of 25 mm and a thickness of 25 μm) left standing on the surface of the cured adhesive for 30 minutes while press-bonding it by using a roller having a weight of 2 kg and moving at a rate of 300 mm/min is peeled off at a peeling rate of 300 mm/min and a peeling angle of 180°, whereby the adhesive force is measured.

The distance between the translucent sheet 110 and the image display unit 130 is particularly from about 25 to about 300 μm. When the distance between the translucent sheet 110 and the image display unit 130 is about 25 μm or more, it is sometimes difficult to fill the space between the translucent sheet 110 and the image display unit 130 only by a liquid adhesive. When the desired distance between the translucent sheet 110 and the image display unit 130 is about 300 μm or less, filling the space between the translucent sheet 110 and the image display unit 130 only by a pressure-sensitive adhesive sheet may allow an air bubble to be present between the pressure-sensitive adhesive sheet and the image display unit 130. Accordingly, when the distance between the translucent sheet 110 and the image display unit 130 is from about 25 to about 300 μm, the benefit of the use of both the pressure-sensitive adhesive sheet 120 and the later-described liquid adhesive is increased. The variation in distance between the translucent sheet 110 and the image display unit 130 is particularly about ±5 μm or less.

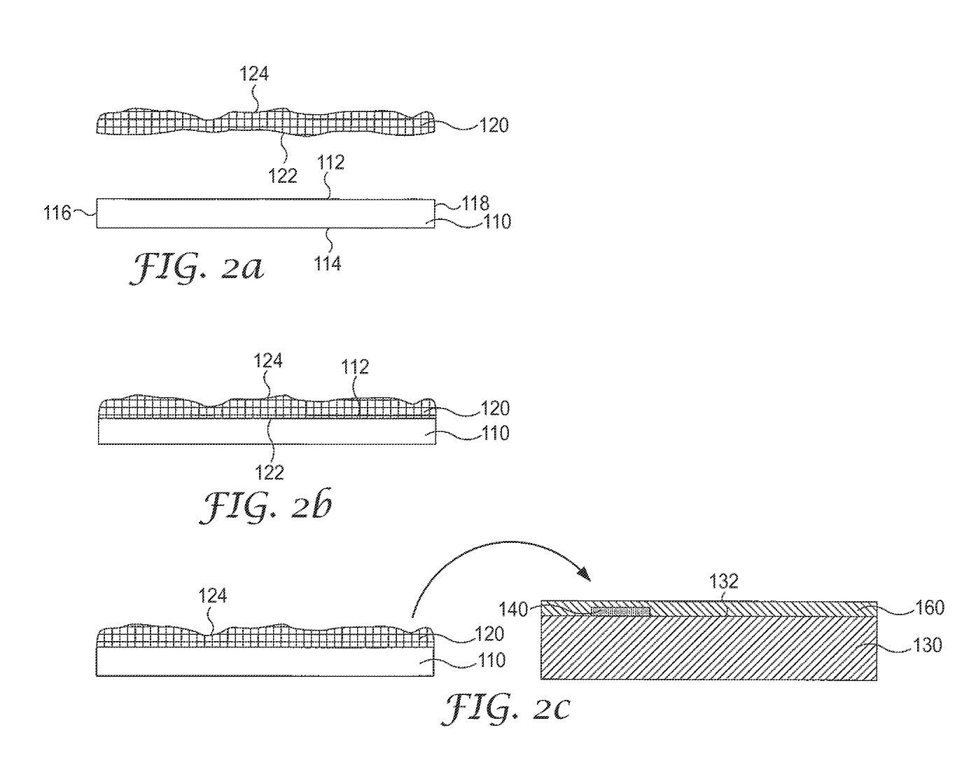

The manufacturing method of an image display device in one embodiment of the present disclosure is described below by referring to FIGS. 2 to 5. The manufacturing method of an image display device comprises a preparation step of providing a translucent sheet, a pressure-sensitive adhesive sheet, a liquid adhesive and an image display unit, a step of laminating the translucent sheet to the pressure-sensitive adhesive sheet, a step of applying the liquid adhesive to the display surface of the image display unit, a step of laminating the pressure-sensitive adhesive sheet laminated with the translucent sheet to the display surface of the image display unit, and a step of curing the liquid adhesive.

### (a) Preparation Step

In the preparation step, a translucent sheet 110 (see, FIG. 2(a)), a pressure-sensitive adhesive sheet 120 (see, FIG. 2(a)), a liquid adhesive 160 (see, FIG. 2(c)), and an image display unit 130 (see, FIG. 2(c)) are prepared. The translucent sheet 110 has a first principal surface 112, a second principal surface 114 opposite the first principal surface 112, a first edge part 116 and a second edge part 118 opposite the first edge part 116. A method of manufacturing an image display device in one embodiment of the present disclosure is suitable for laminating a translucent sheet 110 having a large screen size to an image display unit 130, in particular, the method is suitable for laminating a translucent sheet 110 having a screen size of 10 inches (254 mm) or more to an image display unit 130 with a display surface having a screen size of 10 inches (254 mm) or more. The screen size of the translucent sheet 110 is the diagonal length of a rectangular translucent sheet 110, and the screen size of the display surface of the image display unit 130 is the diagonal length of a rectangular display surface of the image display unit 130.

The pressure-sensitive adhesive sheet 120 has a first principal surface 122 and a second principal surface 124 opposite the first principal surface 122. The pressure-sensitive adhesive sheet 120 has an uneven shape on 122 and/or 124. This uneven shape is produced in the drying step, polymerization step and crosslinking step at the manufacture of the pressure-sensitive adhesive sheet 120. The thickness of the pressure-sensitive adhesive sheet 120 is particularly equal to the distance between the translucent sheet 110 and the image display unit 130. The image display unit 130 has a display surface 132, and at least one step part 140 is disposed on the display surface 132.

The liquid adhesive 160 is a liquid adhesive having fluidity. Examples of the liquid adhesive 160 include, but are not limited to: a vinyl acetate-based adhesive, a polyvinyl alcohol-based adhesive, a polyvinyl acetal-based adhesive, a polyvinyl chloride-based adhesive, an acrylic adhesive, a polyamide-based adhesive, a cellulose-based adhesive, a urea-based adhesive, a melamine-based adhesive, a phenol-based adhesive, an epoxy-based adhesive, a polyester-based adhesive, a polyurethane-based adhesive, a polyaromatic-based adhesive, a chloroprene-based adhesive, a nitrile rubber-based adhesive, a styrene-based adhesive, a butyl rubber-based adhesive, a polysulfide-based adhesive, a silicone rubber-based adhesive, and mixtures thereof. The liquid adhesive 160 is particularly an adhesive of the same or similar chemical class as the pressure-sensitive adhesive of the pressure-sensitive adhesive sheet 120.

In particular, the liquid adhesive 160 is particularly an acrylic adhesive containing 50 wt % or more of an acrylic monomer and/or an acrylic oligomer with a weight average molecular weight of 100,000 or less. Examples of the acrylic monomer and oligomer include, but are not limited to: a (meth)acrylate having a linear alkyl group, such as lauryl (meth)acrylate, cetyl (meth)acrylate (n-C16), stearyl (meth)acrylate (n-C18), aralkyl (meth)acrylate (n-C20) and behenyl (meth)acrylate (n-C22); a (meth)acrylate having a branched alkyl group, such as 2-ethylhexyl (meth)acrylate, isooctyl (meth)acrylate, isononyl (meth)acrylate, isodecyl (meth)acrylate, isododecyl (meth)acrylate, isotridecyl (meth)acrylate, isomyristyl (meth)acrylate, isocetyl (meth)acrylate (iso-C16), isostearyl (meth)acrylate (iso-C18) and 2-octyldodecanyl (meth)acrylate (iso-C20); an alicyclic (meth)acrylate such as cyclohexyl (meth)acrylate, isobornyl (meth)acrylate, tert-butylcyclohexyl (meth)acrylate and dicyclopentenyl (meth)acrylate; an aromatic-containing acrylate such as phenyl (meth)acrylate; a substituted acrylamide such as N,N-dimethylacrylamide, N,N-diethylacrylamide, acryloylmorpholine, N,N-dimethylaminopropylacrylamide, isopropylacrylamide, tert-butylacrylamide and tert-octylacrylamide; a hydroxyl group-containing (meth)acrylate such as 2-hydroxyethyl (meth)acrylate; and a fluorocarbon chain-containing (meth)acrylate. Mixtures of monomers and/or oligomers may be used. The pressure-sensitive adhesive sheet 120 may also be produced using such acrylic monomer(s) and/or oligomer(s) and mixtures thereof.

Representative refractive indexes of these acrylate homopolymers include the following. The refractive index of the alkyl (meth)acrylate is from about 1.42 to about 1.49, the refractive index of the alicyclic (meth)acrylate is from about 1.47 to about 1.51, the refractive index of the aromatic-containing (meth)acrylate is from about 1.47 to about 1.60, and the refractive index of the fluorocarbon chain-containing (meth)acrylate is from about 1.31 to about 1.47.

In order to decrease the refractive index difference between the liquid adhesive 160 and the adherend, a nanofiller such as inorganic fine particles may be added to the liquid adhesive 160 within the amount range where the liquid adhesive 160 is optically transparent. Examples of inorganic fine particles include, but are not limited to: silica, titania, zirconia, ITO, ceria yttria, zinc oxide, a mixture thereof, and a sintered body of a mixture thereof. In order to have optical transparency, the primary particle diameter of the nanofiller is particularly 200 nm or less. In order to decrease the refractive index difference between the pressure-sensitive adhesive sheet 120 and the adherend, the pressure-sensitive adhesive sheet 120 may contain this nanofiller.

The difference between the refractive index of the translucent sheet 110 and the refractive index of the pressure-sensitive adhesive sheet 120, the difference between the refractive index of the pressure-sensitive adhesive sheet 120 and the refractive index of the cured liquid adhesive 160, the difference between the refractive index of the pressure-sensitive adhesive sheet 120 and the refractive index of the display surface 132 of the image display unit 130, and the difference between the refractive index of the cured liquid adhesive 160 and the refractive index of the display surface 132 of the image display unit 130 each is, for example, particularly 0.2 or less. The refractive index of the cured liquid adhesive 160 is particularly between the refractive index of the pressure-sensitive adhesive sheet 120 and the refractive index of the object (for example, the transparent sheet 120, the step part 140 or the display surface 132 of the image display unit 130) on which the liquid adhesive 160 is coated. In this case, the visibility of an image displayed on the image surface 132 of the image display unit 130 can be enhanced. Refractive indexes of examples of the object on which the liquid adhesive 160 is coated are as follows. For example, the refractive index of glass is about 1.5, the refractive index of ITO transparent electrode is about 2.2, the refractive index of triacetyl cellulose film is about 1.49, the refractive index of acrylic (co)polymerizable polymer is from about 1.31 to about 1.60, and the refractive index of polyethylene terephthalate (PET) film is about 1.57.

Other examples of the acrylic monomer and oligomer include, but are not limited to: hexanediol di(meth)acrylate, neopentyl glycol di(meth)acrylate, nonanediol di(meth)acrylate, decanediol di(meth)acrylate, dodecanediol di(meth)acrylate, cyclohexanedimethanol di(meth)acrylate, tricyclodecanedimethanol di(meth)acrylate, hydrogenated bisphenol A di(meth)acrylate, hydrogenated polybutadiene di(meth)acrylate, hydrogenated isoprene di(meth)acrylate and trimethylolpropane tri(meth)acrylate.

In one embodiment, the liquid adhesive 160 is cured under irradiation of an ultraviolet ray or visible light or under heating. The adhesive resulting from curing of this liquid adhesive 160 is the above-described cured adhesive 150. The liquid adhesive contains a radiation (light) polymerization initiator or a thermal polymerization initiator.

In order to enhance the cohesive force between polymers after curing and the adherence to the adherend, the liquid adhesive 160 may contain an isocyanate-based crosslinking agent, an epoxy-based crosslinking agent and a silane coupling agent.

Examples of the radiation (light) polymerization initiator as a radical polymerization initiator include, but are not limited to: benzophenone, 2-methyl-1-[4-(methylthio)phenyl]-2-morpholinopropan-1-one, camphorquinone, benzoin, benzoin methyl ether, benzoin-n-propyl ether, benzoin-n-butyl ether, benzil, p-methylbenzophenone, diacetyl, eosin, thionine, Michler's ketone, acetophenone, 2-chlorothioxanthone, anthraquinone, chloroanthraquinone, 2-methylanthraquinone, α-hydroxyisobutylphenone, p-isopropyl-α-hydroxyisobutylphenone, α,α′-dichloro-4-phenoxyacetophenone, 1-hydroxy-1-cyclohexylacetophenone, 2,2-dimethoxy-2-phenylacetophenone, methylbenzoin formate, dichlorothioxanthone, diisopropylthioxanthone, phenyl-disulfide-2-nitrofluorenone, butyroin, anisoin ethyl ether, tetramethylthiuram disulfide, 2,2-dimethoxy-1,2-diphenylethan-1-one, 1-hydroxy-cyclohexyl-phenyl-ketone, 2-hydroxy-2-methyl-1-phenyl-propan-1-one, 1-[4-(2-hydroxyethoxy)-phenyl]-2-hydroxy-2-methyl-1-propan-1-one, 2-hydroxy-1-{4-[4-(2-hydroxy-2-methyl-propionyl)-benzyl]phenyl}-2-methyl-propan-1-one, 2-methyl-1-(4-methylthiophenyl)-2-morpholinopropan-1-one, 2-benzyl-2-dimethylamino-1-(4-morpholinophenyl)-butanone-1,2-(dimethylamino)-2-[(4-methylphenyl)methyl]-1-[4-(4-morpholinyl)phenyl]-1-butanone, 2,4,6-trimethylbenzoyl-diphenyl-phosphine oxide, and bis(2,4,6-trimethylbenzoyl)-phenylphosphine oxide.

Examples of the thermal polymerization initiator as a radical polymerization initiator include, but are not limited to: an organic peroxide such as isobutyryl peroxide, cumylperoxy neodecanoate, diisopropylperoxy dicarbonate, di-n-propylperoxy dicarbonate, cumylperoxy neohexanoate, di(2-ethoxyethyl)peroxy dicarbonate, di(methoxyisopropyl)peroxy dicarbonate, di(2-ethylhexyl)peroxy dicarbonate, tert-butylperoxy neodecanoate, tert-hexylperoxy neohexanoate, tert-butyrylperoxy neohexanoate, tert-butylperoxy pivalate, lauroyl peroxide, cumylperoxy octate and benzoyl peroxide; and an azo compound such as 2,2′-azobis(4-methoxy-2,4-dimethylvaleronitrile), 2,2′-azobis(2-cyclopropylpropionitrile), 2,2′-azobis(2,4-methylvaleronitrile), 2,2′-azobisisobutyronitrile, 2,2′-azobis(2-methylbutyronitrile), 2,2′-azobis(2-methylpropionate), and 4,4′-azobis(4-cyanovaleric acid).

The viscosity of the liquid adhesive is particularly from about 10 to about 4,000 mPa·s. The viscosity of the liquid adhesive is more particularly from about 50 to about 2,500 mPa·s. This viscosity value is a value measured with a BM-type viscometer by using a #3 rotor at a temperature of 25° C. and a rotation speed of 12 rpm. If the viscosity of the liquid adhesive is less than about 10 mPa·s, the liquid adhesive applied to the adherend may drip in a large amount from the display surface of the adherend, whereas if the viscosity of the liquid adhesive exceeds bout 4,000 mPa·s, the liquid adhesive may not flow and it may become difficult to remove the later-described air bubbles.

The surface energy of the liquid adhesive is particularly about 45 mJ/cm² or less. The surface energy of the liquid adhesive is more particularly about 35 mJ/cm² or less. When the surface energy of the liquid adhesive is about 45 mJ/cm² or less, wettability to the adherend surface is improved, the liquid adhesive easily flows on the adherend surface, and removal of the later-described air bubbles is facilitated. Furthermore, the volatility at ordinary temperature of the liquid adhesive is preferably lower.

### (b) Step of Laminating Pressure-Sensitive Adhesive Sheet to Translucent Sheet

In the step of laminating the pressure-sensitive adhesive sheet to the translucent sheet, as shown in FIG. 2(b), the first principal surface 122 of the pressure-sensitive adhesive sheet 120 is laminated to the first principal surface 112 of the translucent sheet 110. The first principal surface 112 of the translucent sheet 110 is flat and thanks to deformation of the pressure-sensitive adhesive 120, the first principal surface 122 of the pressure-sensitive adhesive sheet 120 becomes flat.

### (c) Step of Applying Liquid Adhesive

In the step of applying the liquid adhesive, as shown in FIG. 2(c), the liquid adhesive 160 is applied to the display surface 132 of the image display unit 130. Examples of the method for applying the liquid adhesive 160 to the display surface 132 of the image display unit 130 include, but are not limited to: a method of spreading or spraying the liquid adhesive 160, a method of dripping droplets of the liquid adhesive 160, and known methods such as a spin coating method, gravure roll coater method, blade coater method, spray coater method, dip coating method, bar coater method, die coater method and wire bar method.

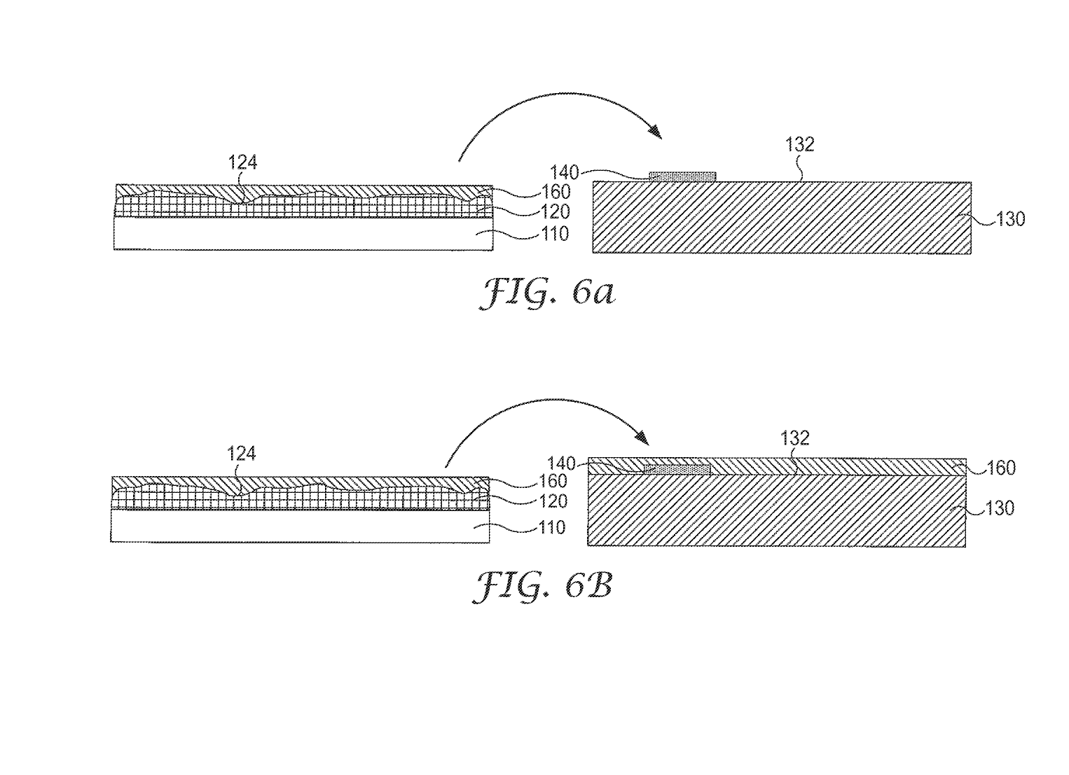

In the step of applying the liquid adhesive in another embodiment, as shown in FIG. 6(a), the liquid adhesive 160 may be applied to the second principal surface 124 of the pressure-sensitive adhesive sheet 120 without applying the liquid adhesive 160 to the display surface 132 of the image display unit 130. Furthermore, in the step of applying the liquid adhesive in still another embodiment, as shown in FIG. 6(b), the liquid adhesive 160 may be applied to the display surface 132 of the image display unit 130 and the second principal surface 124 of the pressure-sensitive adhesive sheet 120.

In the step of applying the liquid adhesive in yet still another embodiment, the liquid adhesive 160 may be applied to a part of the display surface 132 of the image display unit 130. As shown in FIG. 7, for example, the liquid adhesive 160A may be applied to a part of the display surface 132 of the image display unit 130 to cover the step part 140A. At this time, in order to prevent the visibility of an image displayed on the display surface 132 of the image display unit 130 from deteriorating due to a difference between the refractive index of the pressure-sensitive adhesive sheet and the refractive index of the step part 140A, the liquid adhesive 160A may be selected such that the refractive index of the liquid adhesive 160A after curing becomes a value between the refractive index of the pressure-sensitive adhesive sheet and the refractive index of the step part 140A. Also, in the case of applying the liquid adhesive 160 to a part of the display surface 132 of the image display unit 130, the liquid adhesive 160B may be applied to the periphery of the step part 140B.

The liquid adhesive 160 may be applied to a part of the second principal surface 124 of the pressure-sensitive adhesive sheet 120. Also, the liquid adhesive 160 may be applied to a part of the display surface 132 of the image display unit 130 and a part of the second principal surface 124 of the pressure-sensitive adhesive sheet 120. In the case of applying the liquid adhesive 160 to a part of the display surface 132 where a step part having a height of about 0.5 μm or more is disposed, the entire surface of the step part having a height of about 0.5 μm more is preferably coated with the liquid adhesive.

In the case where a step part such as step part due to an ink for decoration and step part formed by pattern printing of a transparent electrode or the like is formed on the first principal surface 112 of the translucent sheet 110, the liquid adhesive 160 may be applied to at least a part of the first principal surface 112 of the translucent sheet 110 before laminating the pressure-sensitive adhesive sheet 120 thereon.

### (d) Step of Laminating Pressure-Sensitive Adhesive Sheet to Image Display Unit

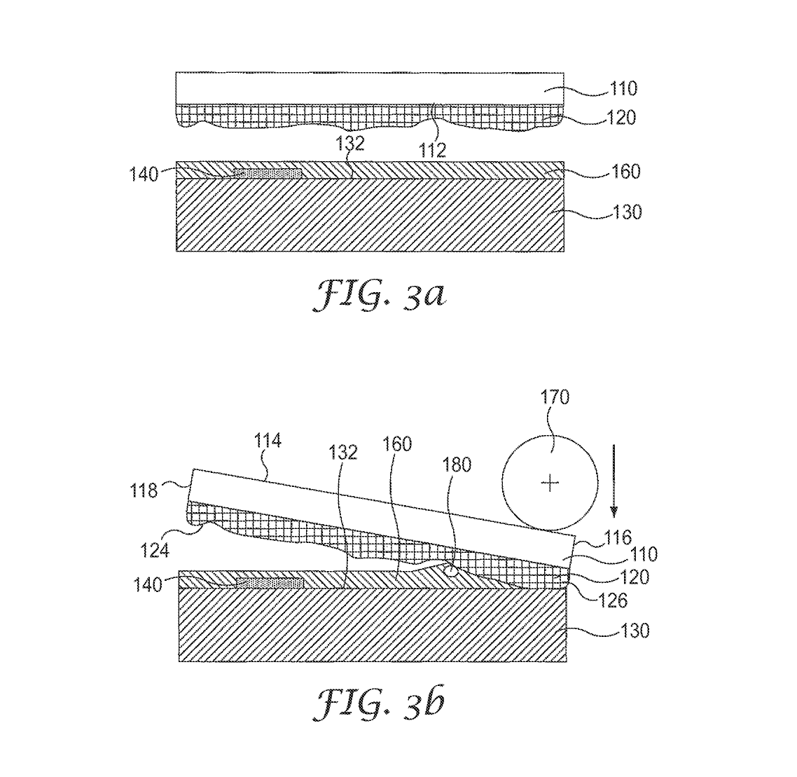

In the step of laminating the pressure-sensitive adhesive sheet to the image display unit, first, as shown in FIG. 3(a), the first principal surface 112 of the translucent sheet 110 is opposed to the display surface 132 of the image display unit 130. Next, as shown in FIG. 3(b), the first edge part 116 of the translucent sheet 110 is put close to the display surface 132 of the image display unit 130 until part of the pressure-sensitive adhesive sheet 120 is laminated to the translucent sheet 110, the portion 126 in the vicinity of the first edge part 116 of the translucent sheet 110 comes into contact with the display surface 132 of the image display unit 130. At this time, as shown in FIG. 3(b), an external force having a component perpendicular to the display surface 132 of the image display unit 130 may be added to the second principal surface 114 of the translucent sheet 110 by using a pressure roller 170. The linear pressure added to the translucent sheet 110 by the pressure roller 170 may be, for example, about 0.1 kg/cm. Also, as shown in FIG. 3(b), in the course of the first edge part 116 of the translucent sheet 110 being put close to the display surface 132 of the image display unit 130, an air bubble 180 is likely to be entrained into the liquid adhesive 160.

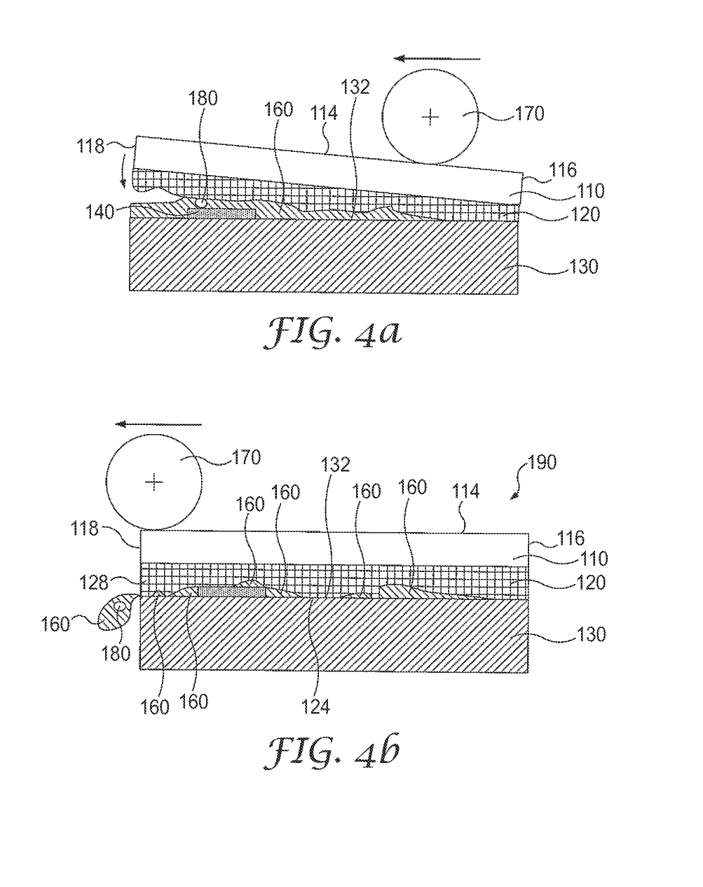

Thereafter, as shown in FIG. 4(a), the second edge part 118 of the translucent sheet 110 is put close to the display surface 132 of the image display unit 130 while flowing the liquid adhesive 160 in the direction to the second edge part 118 from the first edge part 116 of the translucent sheet 110. Due to the flow of the liquid adhesive 160, the air bubble 180 in the liquid adhesive 160 moves in the direction toward the second edge part 118 from the first edge part 116 of the translucent sheet 110. In the case of adding an external force to the second principal surface 114 of the translucent sheet 110 by using a pressure roller 170, as shown in FIG. 4(a), the position at which the external force is added to the second principal surface 114 of the translucent sheet 110 may be moved in the direction toward the second edge part 118 from the first edge part 116 of the translucent sheet 110 by moving the pressure roller 170. For example, the pressure roller 170 may be moved at a rate of about 1.5 cm/sec.

Then, as shown in FIG. 4(b), out of the pressure-sensitive adhesive sheet 120 laminated to the translucent sheet 110, the portion 128 in the vicinity of the second edge part 118 of the translucent sheet 110 comes into contact with the display surface 132 of the image display unit 130, and the second principal surface 124 of the pressure-sensitive adhesive sheet 120 laminated with the translucent sheet 110 is laminated to the display surface 132 of the image display unit 130 to produce a stack 190.

At this time, as shown in FIG. 4(b), the liquid adhesive 160 containing an air bubble 180 may be caused to flow out from between the second principal surface 124 of the pressure-sensitive adhesive sheet 120 and the display surface 132 of the image display unit 130, so that the air bubble 180 (see, FIG. 3(b) and FIG. 4(a)) present between the second principal surface 124 of the pressure-sensitive adhesive sheet 120 laminated to the first principal surface 112 of the translucent sheet 110 and the display surface 132 of the image display unit 130 can be removed. The pressure roller 170 may be moved from the first edge part 116 to the second edge part 118 of the translucent sheet 110 so as to encourage the liquid adhesive 160 to flow out from between the second principal surface 124 of the pressure-sensitive adhesive sheet 120 and the display surface 132 of the image display unit 130.

The gap between the second principal surface 124 of the pressure-sensitive adhesive sheet 120 and the display surface 132 of the image display unit 130, which is attributable to the uneven shape of the adhesive sheet 120, and the gap around the step part 140 are filled with the liquid adhesive 160.

The contact area between the second principal surface 124 of the pressure-sensitive adhesive sheet 120 laminated to the translucent sheet 110 and the display surface 132 of the image display unit 130 is preferably designed to be as large as possible. Thanks to such a contact area, a large amount of the liquid adhesive 160 present between the second principal surface 124 of the pressure-sensitive adhesive sheet 120 laminated to the translucent sheet 110 and the display surface 132 of the image display unit 130 flows out from between the second principal surface 124 of the pressure-sensitive adhesive sheet 120 and the display surface 132 of the image display unit 130, whereby removal of the air bubble is accelerated.

In order to more facilitate the removal of the air bubble 180 (see, FIG. 3(b) and FIG. 4(a)) present between the second principal surface 124 of the pressure-sensitive adhesive sheet 120 laminated to the first principal surface 112 of the translucent sheet 110 and the display surface 132 of the image display unit 130, the step of laminating the pressure-sensitive adhesive sheet to the image display unit may be performed under reduced pressure or under vacuum.

### (e) Step of Curing Liquid Adhesive

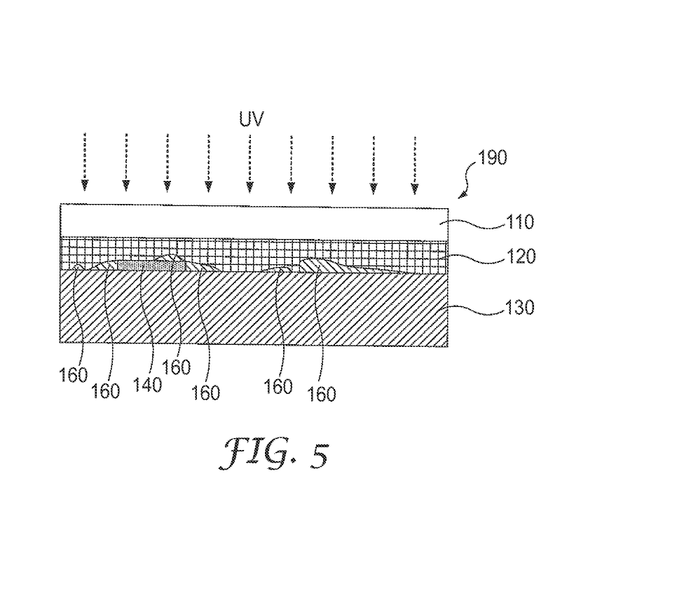

In the case of curing the liquid adhesive 160 with ultraviolet rays, as shown in FIG. 5, the liquid adhesive 160 is cured by irradiating ultraviolet rays (UV) on the stack 190 in the liquid adhesive curing step. In the case of curing the liquid adhesive 160 with visible light, the liquid adhesive 160 is cured by irradiating visible light on the stack 190 in the liquid adhesive curing step; and in the case of curing the liquid adhesive 160 under heating, the liquid adhesive 160 is cured by heating the stack 190 in the liquid adhesive curing step.

The amount of the liquid adhesive 160 remaining between the translucent sheet 110 and the image display unit 130 is small compared to the liquid adhesive remaining between the translucent sheet and the image display unit when the translucent sheet is laminated to the image display unit by using only a liquid adhesive. Accordingly, in the case of curing the liquid adhesive by the irradiation of ultraviolet rays, the irradiation dose of UV can be small as compared with the case of laminating the translucent sheet to the image display unit by using only a liquid adhesive, whereby the damage of the image display unit due to ultraviolet ray can be reduced. Also, the quantity of heat generated during curing of the liquid adhesive is small and therefore, damage to the image display unit due to heat generated during curing of the liquid adhesive can be reduced.

The liquid adhesive 160 undergoes significant volumetric shrinkage at curing. However, the volume of the liquid adhesive 160 remaining between the second principal surface 124 of the pressure-sensitive adhesive sheet 120 and the display surface 132 of the image display unit 130 is small based on the volume of the pressure-sensitive adhesive sheet 120 and therefore, the variation in thickness of the resin layer composed of the pressure-sensitive adhesive sheet 120 and the cured liquid adhesive 160 (cured adhesive 150) and formed between the first principal surface 112 of the translucent sheet 110 and the display surface 132 of the image display unit 130 is small. For example, the variation in thickness of the resin layer can be made to fall within about ±5 μm. In turn, the variation in distance between the first principal surface 112 of the translucent sheet 110 and the display surface 132 of the image display unit 130 can be kept within about ±5 μm. Accordingly, in the case of keeping the variation in distance between the first principal surface 112 of the translucent sheet 110 and the display surface 132 of the image display unit 130 within about ±5 μm, the benefit of the manufacturing method of an image display device in one embodiment of the present disclosure is great.

As the adhesive forces of the cured liquid adhesive 160 and the pressure-sensitive adhesive sheet 120 are higher, better results are obtained in the reliability test of the image display device, such as drop impact test and environmental test (test of deterioration due to heat, wet heat and the like). For this reason, the adhesive force between the translucent sheet 110 and the pressure-sensitive adhesive sheet 120, the adhesive force between the pressure-sensitive adhesive sheet 120 and the cured liquid adhesive 160, the adhesive force between the pressure-sensitive adhesive sheet 120 and the display surface 132 of the image display unit 130, and the adhesive force between the cured liquid adhesive 160 and the display surface 132 of the image display unit 130 each is preferably, for example, about 1 N/25 mm or more.

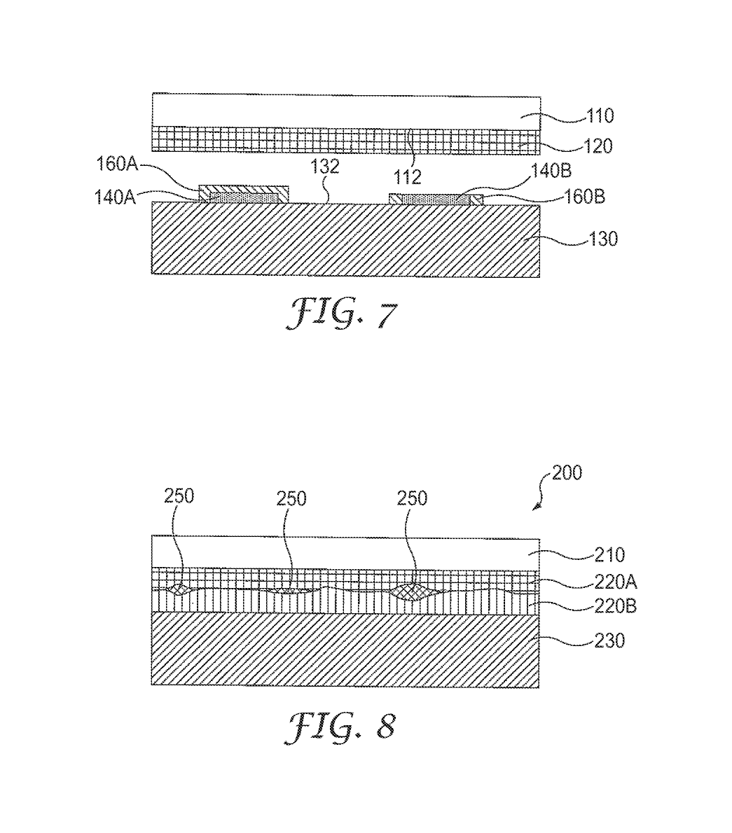

FIG. 8 shows a cross-sectional view of the image display device manufactured by a method of manufacturing an image display device according to another embodiment of the present. The image display device 200 comprises a translucent sheet 210 and an image display unit 230. Two pressure-sensitive adhesive sheets 220A and 220B are disposed in a stacked manner between the translucent sheet 210 and the image display unit 230, and a cured adhesive 250 is filled in the gap between two pressure-sensitive adhesive sheets 220A and 220B. The translucent sheet 210, the pressure-sensitive adhesive sheets 220A and 220B, the image display unit 230 and the cured adhesive 250 are the same as the translucent sheet 110, the pressure-sensitive adhesive sheet 120, the image display unit 130 and the cured adhesive 150 in the embodiment described above. The materials of the two pressure-sensitive adhesive sheets 220A and 220B may be the same or different.

The method of manufacturing an image display device according to another embodiment of the present disclosure comprises a preparation step of providing a translucent sheet, a first pressure-sensitive adhesive sheet, a second pressure-sensitive adhesive sheet, a liquid adhesive and an image display unit, a step of laminating the first pressure-sensitive adhesive sheet to the translucent sheet, a step of laminating the second pressure-sensitive adhesive sheet to the display surface of the image display unit, a step of applying the liquid adhesive to at least a part of at least either one of the first pressure-sensitive adhesive sheet and the second pressure-sensitive adhesive sheet, a step of laminating the first pressure-sensitive adhesive sheet laminated with the translucent sheet to the second pressure-sensitive adhesive sheet laminated with the display surface of the image display unit, and a step of curing the liquid adhesive.

Specifically, the manufacturing method of an image display device in another embodiment of the present disclosure may be as follows.

### (a) Preparation Step

In the preparation step, although not shown in the figure, a translucent sheet, a first pressure-sensitive adhesive sheet, a second pressure-sensitive adhesive sheet, a liquid adhesive, and an image display unit are prepared. The translucent sheet, the first pressure-sensitive adhesive sheet, the second pressure-sensitive adhesive sheet, the image display unit and the liquid adhesive are the same as the translucent sheet 110, the pressure-sensitive adhesive sheet 120, the image display unit 130 and the liquid adhesive 160 in the embodiment described above. The materials of the first pressure-sensitive adhesive sheet and the second pressure-sensitive adhesive sheet may be the same or different. Similarly to the embodiment described above, the translucent sheet has a first principal surface, a second principal surface opposite the first principal surface, a first edge part and a second edge part opposite the first edge part. Also, similarly to the embodiment described above, each of the first pressure-sensitive adhesive sheet and the second pressure-sensitive adhesive sheet has a first principal surface and a second principal surface opposite the first principal surface. Furthermore, similarly to the embodiment described above, the image display unit has a display surface.

### (b) Step of Laminating First Pressure-Sensitive Adhesive Sheet to Translucent Sheet

In the step of laminating the first pressure-sensitive adhesive sheet to the translucent sheet, the first principal surface of the pressure-sensitive adhesive sheet is laminated to the first principal surface of the translucent sheet.

### (c) Step of Laminating Second Pressure-Sensitive Adhesive Sheet to Image Display Unit

In the step of laminating the second pressure-sensitive adhesive sheet to the image display unit, the first principal surface of the second pressure-sensitive adhesive sheet is laminated to the display surface of the image display unit.

### (d) Step of Applying Liquid Adhesive

In the step of applying the liquid adhesive, the liquid adhesive is applied to at least a part of either one surface of the second principal surface of the first pressure-sensitive adhesive sheet or the second principal surface of the second pressure-sensitive adhesive sheet. The method for applying the liquid adhesive is the same as in the above-described one embodiment.

### (e) Step of Laminating First Pressure-Sensitive Adhesive Sheet to Second Pressure-Sensitive Adhesive Sheet

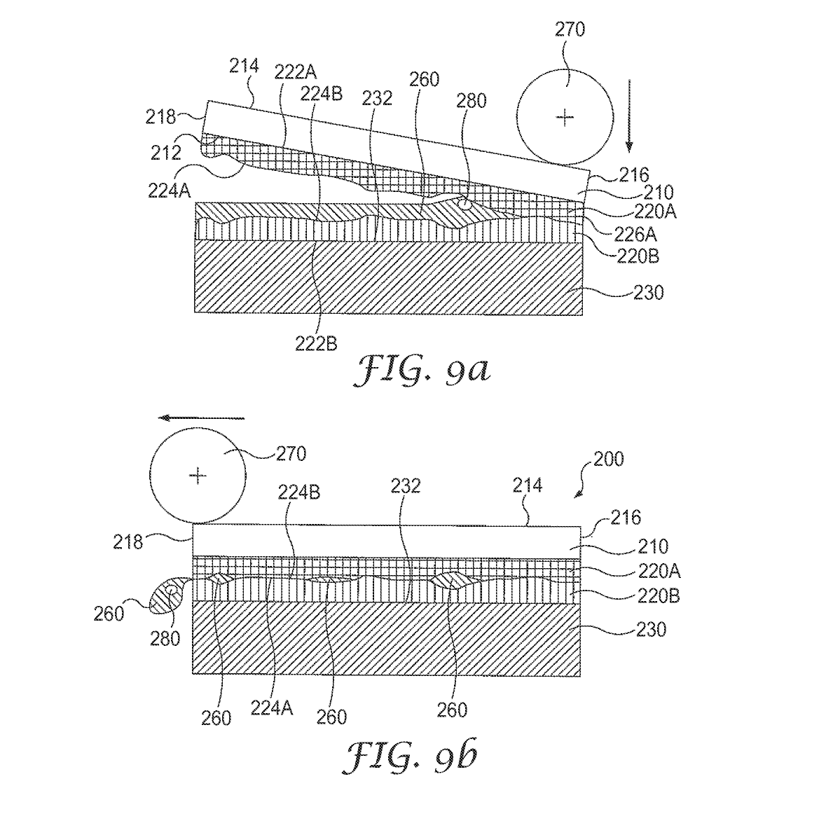

In the step of laminating the first pressure-sensitive adhesive sheet to the second pressure-sensitive adhesive sheet, the first principal surface of the translucent sheet is opposed to the display surface of the image display unit. Next, as shown in FIG. 9(a), the first edge part 216 of the translucent sheet 210 is put close to the display surface 232 of the image display unit 230 until out of the first pressure-sensitive adhesive sheet 220A laminated to the translucent sheet 210, the portion 226A in the vicinity of the first edge part 216 of the translucent sheet 210 comes into contact with the second principal surface 224B of the second pressure-sensitive adhesive sheet 220B laminated to the display surface 232 of the image display unit 230.

Numeral 210 indicates the translucent sheet, numeral 212 indicates the first principal surface of the translucent sheet, numeral 214 indicates the second principal surface of the translucent sheet, numeral 216 indicates the first edge part of the translucent sheet, and numeral 218 indicates the second edge part of the translucent sheet. Numeral 220A indicates the first pressure-sensitive adhesive sheet, numeral 222A indicates the first principal surface of the first pressure-sensitive adhesive sheet, and numeral 224A indicates the second principal surface of the first pressure-sensitive adhesive sheet. Numeral 220B indicates the second pressure-sensitive adhesive sheet, numeral 222B indicates the first principal surface of the second pressure-sensitive adhesive sheet, and numeral 224B indicates the second principal surface of the second pressure-sensitive adhesive sheet. Numeral 230 indicates the image display unit, and numeral 232 indicates the display surface of the image display unit. Numeral 260 indicates the liquid adhesive.

As shown in FIG. 9(a), an external force having a component perpendicular to the display surface 232 of the image display unit 230 may be added to the second principal surface 214 of the translucent sheet 210 by using a pressure roller 270. The linear pressure added to the translucent sheet 210 by the pressure roller 270 may be, for example, about 0.1 kg/cm. Also, as shown in FIG. 9(a), in the course of the first edge part 216 of the translucent sheet 210 being put close to the display surface 232 of the image display unit 230, an air bubble 280 is likely to be entrained into the liquid adhesive 260.

Thereafter, as shown in FIG. 9(b), the second edge part 218 of the translucent sheet 210 is put close to the display surface 232 of the image display unit 230 while flowing the liquid adhesive 260 in the direction to the second edge part 218 from the first edge part 216 of the translucent sheet 210, and the second principal surface 224A of the first pressure-sensitive adhesive sheet 220A laminated with the translucent sheet 210 is laminated to the second principal surface 224B of the second pressure-sensitive adhesive sheet 220B laminated with the display surface 232 of the image display unit 230. At this time, the liquid adhesive 260 containing an air bubble 280 may flow out from between the second principal surface 224A of the first pressure-sensitive adhesive sheet 220A and the second principal surface 224B of the second pressure-sensitive adhesive sheet 220B, so that the air bubble present between the second principal surface 224A of the first pressure-sensitive adhesive sheet 220A laminated to the first principal surface 212 of the translucent sheet 210 and the second principal surface 224B of the second pressure-sensitive adhesive sheet 220B laminated to the display surface 232 of the image display unit 230 can be removed.

In the case of adding an external force to the second principal surface 214 of the translucent sheet 210 by using a pressure roller 270, as shown in FIG. 9(b), the position at which the external force is added to the second principal surface 214 of the translucent sheet 210 may be moved in the direction toward the second edge part 218 from the first edge part 216 of the translucent sheet 210 by moving the pressure roller 270. For example, the pressure roller 270 may be moved at a rate of about 1.5 cm/sec.

In order to facilitate the removal of the air bubble present between the second principal surface 224A of the first pressure-sensitive adhesive sheet 220A laminated to the first principal surface 212 of the translucent sheet 210 and the second principal surface 224B of the second pressure-sensitive adhesive sheet 220B laminated to the display surface 232 of the image display unit 230, the step of laminating the first pressure-sensitive adhesive sheet-the second pressure-sensitive adhesive sheet may be performed under reduced pressure or under vacuum.

### (f) Step of Curing Liquid Adhesive

In the step of curing the liquid adhesive, the liquid adhesive 260 is cured by the same method as in the above-described embodiment.

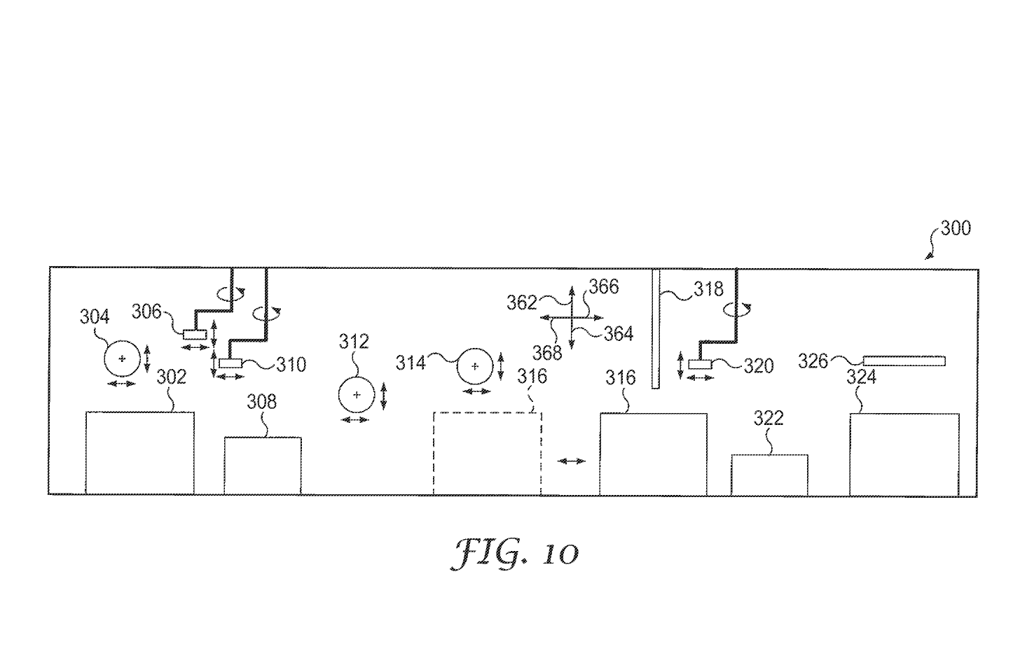

One embodiment of the image display device manufacturing apparatus for manufacturing an image display device by the manufacturing method of an image display device in one embodiment of the present disclosure is described below by referring to FIG. 10. However, the manufacturing apparatus of an image display device of the present disclosure is not limited to the following embodiment.

FIG. 10 is a schematic view of the manufacturing apparatus 300 of an image display device according to one embodiment of the present disclosure. The manufacturing apparatus 300 of an image display device comprises a stage A 302, pressure rollers 304 and 314, a conveyer 306, a translucent sheet place 308, a translucent sheet feeder 310, an adhesion roller 312, a stage B 316, a liquid adhesive feeder 318, an image display unit feeder 320, an image display unit place 322, a stage C 324 and a UV lamp 326. Hereinafter, the arrow 362 in FIG. 10 is referred to as an up direction, the arrow 364 is referred to as a down direction, the arrow 366 is referred to as a front direction, and the arrow 368 is referred to as a rear direction.

The stage A 302 is a stand used when laminating the pressure-sensitive adhesive sheet 120 to the translucent sheet 110. The pressure-sensitive adhesive sheet 120 is put on the stage A 302, the translucent sheet 110 is put on the pressure-sensitive adhesive sheet 120, and the pressure-sensitive adhesive sheet 120 is laminated to the translucent sheet 110. The pressure roller 304 is used for applying a pressure to the translucent sheet 110 when laminating the pressure-sensitive adhesive sheet 120 to the translucent sheet 110. The pressure roller 304 can move in the up-and-down direction and the front-and-rear direction and can rotate around the axis running in the up-and-down direction.

The conveyer 306 is used when transferring the sample from the stage A 302 to the stage B 316 and from the stage B 316 to the stage C 324. The conveyer 306 has an adsorption part and holds the sample by adsorbing the adsorption part to the sample. The conveyer 306 can move in the up-and-down direction and the front-and-rear direction and can rotate around the axis running in the up-and-down direction.

The translucent sheet place 308 is a stand for putting the translucent sheet 110 thereon so as to prepare a translucent sheet 110 before laminating the pressure-sensitive adhesive sheet 120. The translucent sheet feeder 310 feeds the translucent sheet 110 onto the translucent sheet place 308, and then onto the stage A 302. The translucent sheet feeder 310 has an adsorption part and transfers the translucent sheet 110 from the translucent sheet place 308 to the stage A 302 by adsorbing the adsorption part to the translucent sheet 110. The translucent sheet feeder 310 can move in the up-and-down direction and the front-and-rear direction and can rotate around the axis running in the up-and-down direction.

The adhesion roller 312 strips a liner film attached to the pressure-sensitive adhesive sheet 120 from the pressure-sensitive adhesive sheet 120. The surface of the adhesion roller 312 has adherence, and the liner film adheres to the surface of the adhesion roller 312. The adhesion roller 312 can move in the up-and-down direction and the front-and-rear direction. The pressure roller 314 is used for applying a pressure to the translucent sheet 110 when laminating the translucent sheet 110 laminated with the pressure-sensitive adhesive sheet 120 to the image display unit 130 to which the liquid adhesive 160 is applied. The pressure roller 314 can move in the up-and-down direction and the front-and-back direction.

The stage B 316 is a stand used when laminating the translucent sheet 110 laminated with the pressure-sensitive adhesive sheet 120 to the image display unit 130 to which the liquid adhesive 160 is applied. The image display unit 130 is put on the stage B 316, the translucent sheet 110 is then put on the image display unit 130, and the translucent sheet 110 laminated with the pressure-sensitive adhesive sheet 120 is laminated to the image display unit 130 to which the liquid adhesive 160 is applied. Also, the stage B 316 is used when applying the liquid adhesive 160 to the image display unit 130. The stage B 316 can move in the front-and-rear direction. The liquid adhesive feeder 318 spreads the liquid adhesive 160 on the image display unit 130 put on the stage B 316.

The image display unit place 322 is a stand for putting the image display unit 130 thereon so as to prepare an image display unit 130 before applying the liquid adhesive 160. The image display unit feeder 320 feeds the image display unit 130 on the image display unit place 322, and then onto the stage B 316. The image display unit feeder 320 has an adsorption part and after adsorbing the adsorption part to the image display unit 130, transfers the image display unit 130 from the image display unit place 322 to the stage B 316. The image display unit feeder 320 can move in the up-and-down direction and the front-and-rear direction and can rotate around the axis running in the up-and-down direction. The UV lamp 326 irradiates ultraviolet rays on the stack 190. The stage C 324 is a stand used when irradiating ultraviolet rays on the stack 190. The stack 190 is put on the stage C 324, and ultraviolet rays are irradiated on the stack 190 by using the UV lamp 326.

The method of manufacturing an image display device when using the image display device manufacturing apparatus 300 in one embodiment of the present disclosure is described by referring to the drawings.

### (a) Preparation Step

In the image display device manufacturing apparatus 300, a translucent sheet 110, a pressure-sensitive adhesive sheet 120, a liquid adhesive 160 and an image display unit 130 are previously prepared. The translucent sheet 110 is put on the translucent sheet place 308, the pressure-sensitive adhesive sheet 120 is housed in the pressure-sensitive adhesive sheet feeder (not shown), the liquid adhesive 160 is contained in a tank (not shown) connected to the liquid adhesive feeder 318, and the image display unit 130 is put on the image display unit place 322.

### (b) Step of Laminating Pressure-Sensitive Adhesive Sheet to Translucent Sheet

As shown in FIG. 11(a), the pressure-sensitive adhesive sheet 120 is put on the stage A 302. A liner film 120A is attached to the pressure-sensitive adhesive sheet 120 so as to prevent the pressure-sensitive adhesive sheet 120 from attaching to the stage A 302. The stage A 302 may be designed to suction the liner film 120A so as to keep immobile the pressure-sensitive adhesive sheet 120 having attached thereto the liner film 120A.

As shown in FIG. 11(b), the translucent sheet 110 put on the translucent sheet place 308 is transferred to the stage A 302 by using the translucent sheet feeder 310 and put on the pressure-sensitive adhesive sheet 120. Then, as shown in FIG. 11(c), the pressure roller 310 is moved on the translucent sheet 110, whereby the pressure-sensitive adhesive sheet 120 is laminated to the translucent sheet 110.

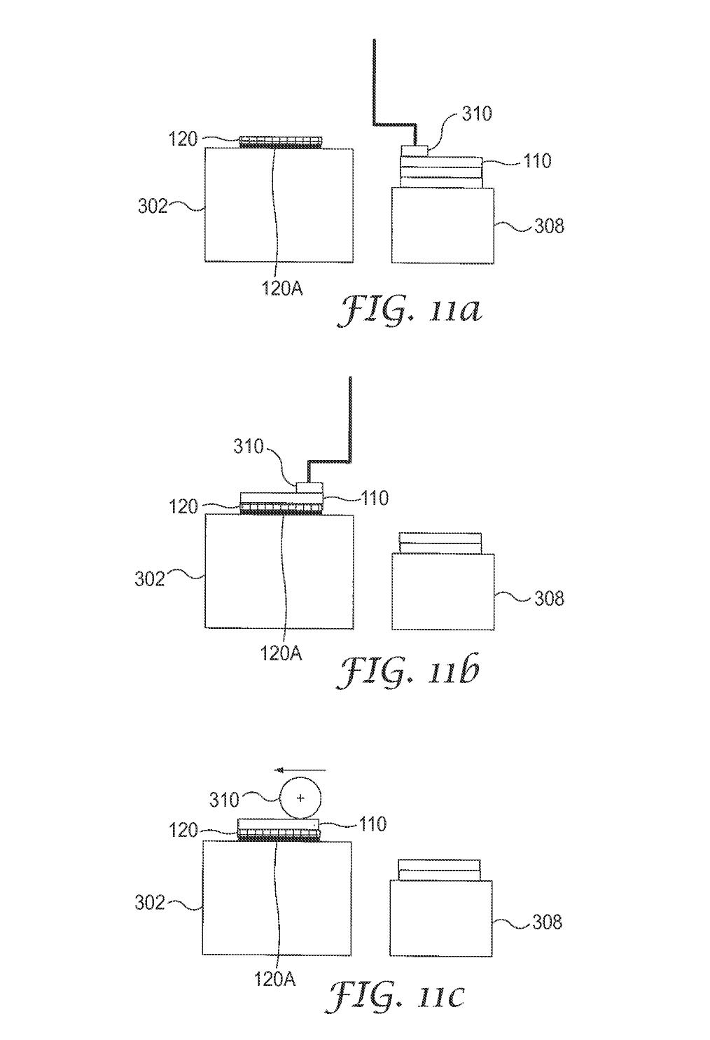

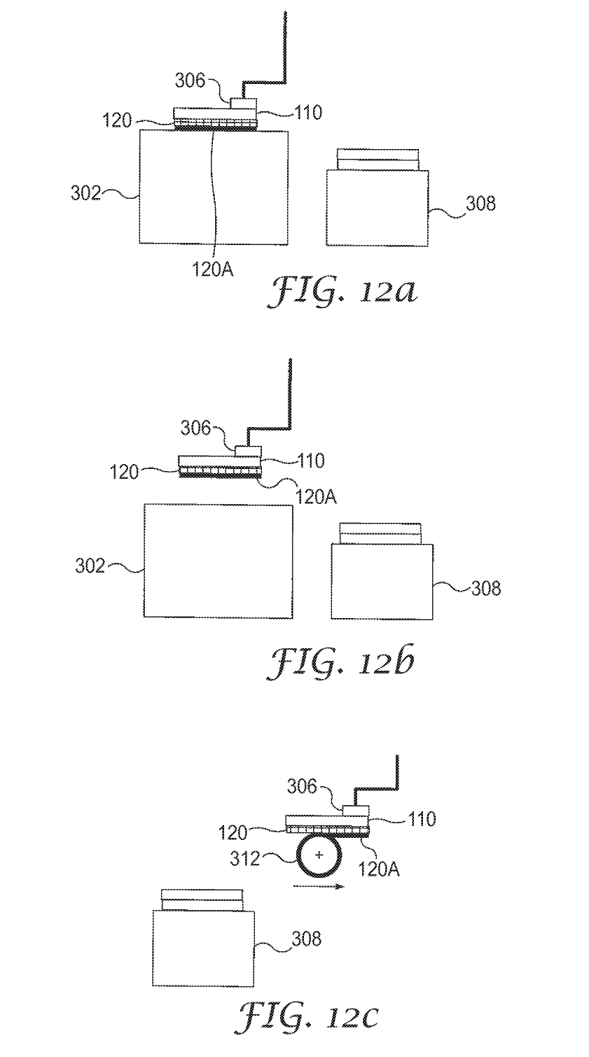

As shown in FIGS. 12(a) and 12(b), the conveyer 306 holds the translucent sheet 110 laminated with the pressure-sensitive adhesive sheet 120 and lifts the translucent sheet 110 laminated with the pressure-sensitive adhesive sheet 120. Then, as shown in FIG. 12(c), the conveyer 306 transfers the translucent sheet 110 laminated with the pressure-sensitive adhesive sheet 120 to the front direction, and the adhesion roller 312 strips the liner film 120A from the pressure-sensitive adhesive sheet 120.

### (c) Step of Applying Liquid Adhesive

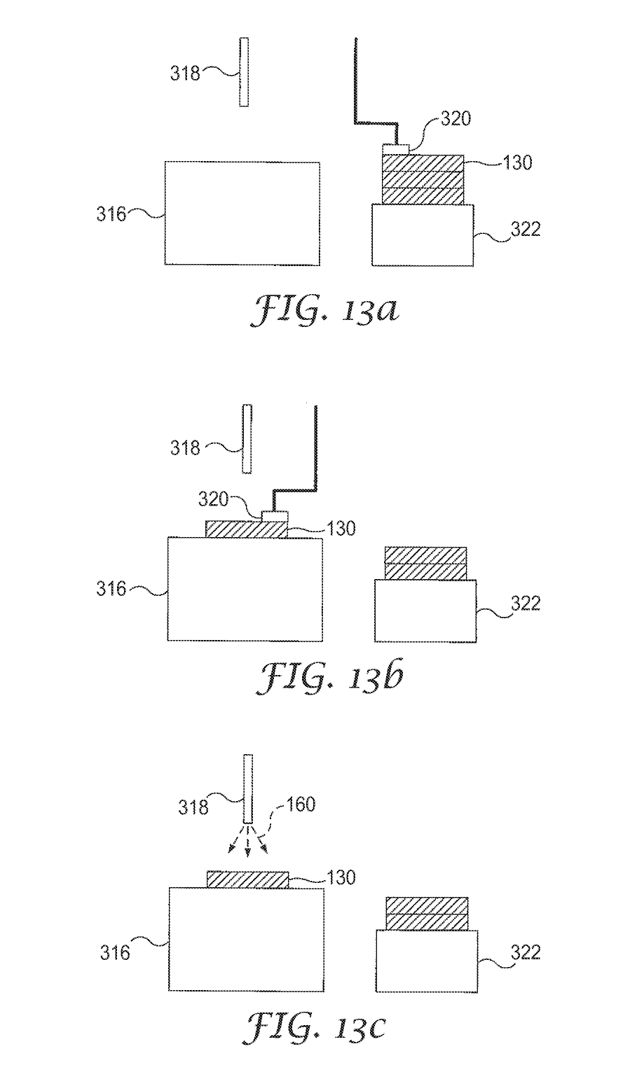

During the step of laminating the pressure-sensitive adhesive sheet 120 to the translucent sheet 110, a step of applying the liquid adhesive to the image display unit is performed. As shown in FIGS. 13(a) and 13(b), the image display unit 130 put on the image display unit place 322 is put on the stage B 316 by using the image display unit feeder 320. Then, as shown in FIG. 13(c), the liquid adhesive 160 is spread from the liquid adhesive feeder 318 to apply the liquid adhesive 160 to the image display unit 130.

### (d) Step of Laminating Pressure-Sensitive Adhesive Sheet to Image Display Unit

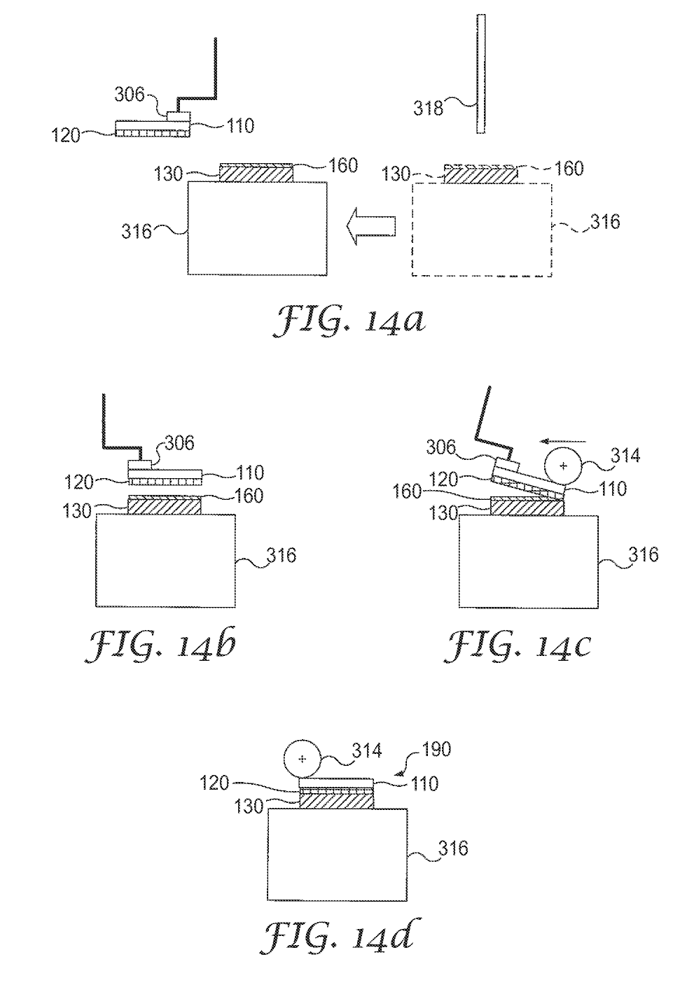

As shown in FIG. 14(a), after applying the liquid adhesive to the image display unit 130, the stage B 316 is moved to the rear direction. As shown in FIG. 14(b), the translucent sheet 110 laminated with the pressure-sensitive adhesive sheet 120 is opposed to the image display unit 130 applied with the liquid adhesive 160, by using the conveyer 306. As shown in FIG. 14(c), when the pressure roller 314 is pressed to the edge part of the translucent sheet 110, the pressure-sensitive adhesive sheet 120 in the vicinity of the edge part of the translucent sheet 110 comes into contact with the image display unit 130. Then, the pressure roller 314 moves to the rear direction. As shown in FIG. 14(d), when the pressure roller 314 moves to the rear direction, the pressure-sensitive adhesive sheet 120 laminated with the translucent sheet 110 is laminated to the image display unit 130, whereby a stack 190 is produced.

### (e) Step of Curing Liquid Adhesive

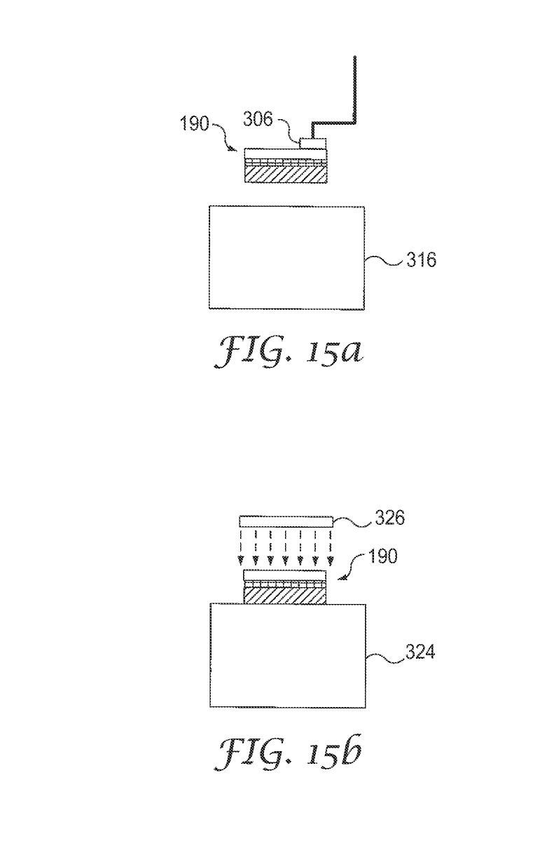

As shown in FIG. 15(a), the conveyer 306 holds the stack 190 and lifts it from the stage B 316. Thereafter, the conveyer 306 transfers the stack 190 onto the stage C 324. As shown in FIG. 15(b), the stack 190 on the stage C 324 is irradiated with ultraviolet rays from the UV lamp 326, and the liquid adhesive remaining between the pressure-sensitive adhesive sheet 120 and the image display unit 130 is thereby cured.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following example are on a weight basis.

### A. Production of Liquid Adhesive

Liquid adhesives differing in the viscosity were produced by mixing the following Solution A and Solution B in different ratios.

Solution A was produced as follows. 0.04 Parts of IRG 651 (produced by Ciba Chemical) as a photopolymerization initiator was added to 90 parts of 2-ethylhexyl acrylate (EHA) and 10 parts of acrylic acid (AA) to prepare a mixture. This mixture was irradiated with ultraviolet rays to adjust the viscosity of the mixture to about 4,000 mPa·s and thereafter, 1.0 part of IRG 651 (produced by Ciba Chemical) was added to the mixture to produce Solution A.

Solution B was produced as follows. 1.0 Part of IRG 651 (produced by Ciba Chemical) was added to a monomer mixture of 90 parts of 2-ethylhexyl acrylate (EHA) and 10 parts of acrylic acid (AA) to produce Solution B.

Solution A and Solution B were mixed by varying the ratio of Solution A vs. Solution B to produce a plurality of liquid adhesives differing in the viscosity. The viscosity was measured with a BM-type viscometer by using a #3 rotor at a temperature of 25° C. and a rotation speed of 12 rpm. Liquid Adhesive 6 was produced to have a viscosity of 250 mPa·s by appropriately mixing Solution A and Solution B. The ratio of Solution A vs. Solution B and the viscosity of the liquid adhesive are shown in Table 1. As for Liquid Adhesive 6, only the viscosity is shown.

TABLE 1
Liquid Adhesive and Viscosity Thereof

| | Ratio of Solution | Ratio of Solution | Viscosity, |
|---|---|---|---|
| Liquid Adhesive | A, wt % | B, wt % | mPa · s |
| Liquid Adhesive 1 | 100 | 0 | 6900 |
| Liquid Adhesive 2 | 75 | 25 | 2000 |
| Liquid Adhesive 3 | 50 | 50 | 450 |
| Liquid Adhesive 4 | 25 | 75 | 45 |
| Liquid Adhesive 5 | 0 | 100 | 4 |
| Liquid Adhesive 6 | — | — | 250 |

### B. Production of Sample for Evaluation

Out of a pair of transparent glass plates having a size of 55 mm×85 mm×2 mm, one transparent glass sheet was laminated with a 175 μm-thick pressure-sensitive adhesive sheet by using a hand roller. This pressure-sensitive adhesive sheet was obtained by adding 0.065 parts of 1,6-hexanediol diacrylate to 87.5 parts of isooctyl acrylate and 12.5 parts of acrylic acid, further adding a photoradical initiator, coating the mixture on a PET film surface-treated with silicone, and irradiating ultraviolet rays thereon. A liquid adhesive, Liquid Adhesive 1 was dropped on the other transparent glass plate out of the pair of transparent glass plates. Subsequently, the pressure-sensitive adhesive sheet-laminated surface of one transparent glass plate was opposed to the liquid adhesive-applied surface of the other transparent glass plate, and one short side (55 mm wide) of the transparent glass plate laminated with the pressure-sensitive adhesive sheet was superposed on one short side of the transparent glass plate to which Liquid Adhesives 1 was applied. Thereafter, the other short side of the transparent glass plate laminated with the pressure-sensitive adhesive sheet was gradually put close to the other short side of the transparent glass plate applied with the liquid adhesive so as to allow the liquid adhesive to flow from one side to the other side of the transparent glass plate, and the transparent glass plate laminated with the pressure-sensitive adhesive sheet was adhered together with the transparent glass plate applied with the liquid adhesive. At this time, a hand roller was used for accelerating the flowing of liquid adhesive. After that, an ultraviolet ray of 365 nm was irradiated at an irradiation does of 1,000 mJ or more on the pair of transparent glass plates adhered together to cure the liquid adhesive, whereby Examples 1 was produced. Examples 2 through 5 were prepared as described for Example 1, except Liquid Adhesive 1 was replaced by Liquid Adhesive 2 through 5, respectively. For comparison, the sample of Comparative Example 1 where a pair of transparent glass plates were adhered together only by the pressure-sensitive adhesive sheet, was also produced.

A step part of 25 mm×25 mm×41 μm was formed on the surface of another transparent glass plate used in Example 1 by cutting out, laminating together and stacking a 16 μm-thick PET film and a 25 μm-thick pressure-sensitive adhesive sheet. Thereafter, the samples of Examples 6 to 10 were produced by the same production method as the production method of Examples 1 to 5.

A pair of transparent glass plates (Eagle 2000, produced by Corning Inc.) having a size of 220 mm×300 mm×2 mm were adhered together using Liquid Adhesive 3 to produce the sample of Example 11. The production method of Example 11 is the same as the production method of Example 3 except for the size of the transparent glass plate.

The same pressure-sensitive adhesive sheet as in Example 1 was laminated to a polarizing plate film (produced by Sanritz Corp.), and the polarizing plate film was adhered together with a transparent glass plate of 50 mm×50 mm×2 mm in the same manner as in Example 1 by using Liquid Adhesive 6 to produce the sample of Example 12 or adhered together with a transparent glass plate of 500 mm×500 mm×2 mm to produce the sample of Example 13. For comparison, the polarizing plate film was adhered together with a transparent glass plate of 50 mm×50 mm×2 mm by using only a pressure-sensitive adhesive tape to produce the sample of Comparative Example 2, and the polarizing plate film was adhered together with a transparent glass plate of 50 mm×50 mm×2 mm by using only Liquid Adhesive 6 to produce the sample of Comparative Example 3.

A pair of transparent glass plates of 50 mm×50 mm×2 mm was adhered together in the same manner as in Example 1 by using Liquid Adhesive 6 to produce the sample of Example 14. Similarly, following the procedure of Example 1 and using Liquid Adhesive 6, a pair of transparent glass plates of 500 mm×500 mm×2 mm were adhered together to produce the sample of Example 15. For comparison, a pair of transparent glass plates of 50 mm×50 mm×2 mm were adhered together using only the pressure-sensitive adhesive sheet to produce the sample of Comparative Example 4, and a pair of transparent glass plates of 50 mm×50 mm×2 mm were adhered together using only Liquid Adhesive 6 to produce the sample of Comparative Example 5.

Samples produced for evaluation are shown in Table 2.

TABLE 2
Samples for Evaluation

| Sample | Liquid Adhesive | Step Part | Objects Adhered Together | | Size |
|---|---|---|---|---|---|
| Example 1 | Liquid Adhesive 1 | none | transparent | transparent | 55 mm × 85 mm × |
| | | | glass plate | glass plate | 2 mm |
| Example 2 | Liquid Adhesive 2 | none | transparent | transparent | 55 mm × 85 mm × |
| | | | glass plate | glass plate | 2 mm |
| Example 3 | Liquid Adhesive 3 | none | transparent | transparent | 55 mm × 85 mm × |
| | | | glass plate | glass plate | 2 mm |
| Example 4 | Liquid Adhesive 4 | none | transparent | transparent | 55 mm × 85 mm × |
| | | | glass plate | glass plate | 2 mm |
| Example 5 | Liquid Adhesive 5 | none | transparent | transparent | 55 mm × 85 mm × |
| | | | glass plate | glass plate | 2 mm |
| Example 6 | Liquid Adhesive 1 | formed | transparent | transparent | 55 mm × 85 mm × |
| | | | glass plate | glass plate | 2 mm |
| Example 7 | Liquid Adhesive 2 | formed | transparent | transparent | 55 mm × 85 mm × |
| | | | glass plate | glass plate | 2 mm |
| Example 8 | Liquid Adhesive 3 | formed | transparent | transparent | 55 mm × 85 mm × |
| | | | glass plate | glass plate | 2 mm |
| Example 9 | Liquid Adhesive 4 | formed | transparent | transparent | 55 mm × 85 mm × |
| | | | glass plate | glass plate | 2 mm |
| Example 10 | Liquid Adhesive 5 | formed | transparent | transparent | 55 mm × 85 mm × |
| | | | glass plate | glass plate | 2 mm |
| Example 11 | Liquid Adhesive 3 | none | transparent | transparent | 220 mm × 300 mm × |
| | | | glass plate | glass plate | 2 mm |
| Example 12 | Liquid Adhesive 6 | none | polarizing plate | transparent | 50 mm × 50 mm × 2 mm |
| | | | film | glass plate | |
| Example 13 | Liquid Adhesive 6 | none | polarizing plate | transparent | 500 mm × 500 mm × |
| | | | film | glass plate | 2 mm |
| Example 14 | Liquid Adhesive 6 | none | transparent | transparent | 50 mm × 50 mm × |
| | | | glass plate | glass plate | 2 mm |
| Example 15 | Liquid Adhesive 6 | none | transparent | transparent | 500 mm × 500 mm × |
| | | | glass plate | glass plate | 2 mm |
| Comparative | none | none | transparent | transparent | 55 mm × 85 mm × |
| Example 1 | | | glass plate | glass plate | 2 mm |
| Comparative | none | none | polarizing plate | transparent | 50 mm × 50 mm × |
| Example 2 | | | film | glass plate | 2 mm |
| Comparative | Liquid Adhesive 6 | none | polarizing plate | transparent | 50 mm × 50 mm × |
| Example 3 | (without pressure-sensitive | | film | glass plate | 2 mm |
| | adhesive sheet) | | | | |
| Comparative | none | none | transparent | transparent | 50 mm × 50 mm × |
| Example 4 | | | glass plate | glass plate | 2 mm |
| Comparative | Liquid Adhesive 6 | none | transparent | transparent | 50 mm × 50 mm × |
| Example 5 | (without pressure-sensitive | | glass plate | glass plate | 2 mm |
| | adhesive sheet) | | | | |

### C. Test Item and Test Method

### Test for Confirming Presence or Absence of Air Bubble

The relationship between the viscosity of the liquid adhesive and the number of air bubbles entrained when adhering together translucent sheets was examined. The test for confirming the presence or absence of an air bubble was performed by visually counting the number of air bubbles in the samples of Examples 1 to 5 and Comparative Example 1.

### Test for Confirming Gap Due to Step Part

Whether the gap between the transparent glass sheet and the pressure-sensitive adhesive sheet, which is generated due to a step part, is filled with the liquid adhesive was examined. The test for confirming the gap due to a step part was performed by visually observing the periphery of the step part in the samples of Examples 6 to 10.

### Test for Confirming Presence or Absence of Air Bubble in Use of Large Glass Plate

Whether large transparent glass plates can be adhered together without entraining an air bubble was confirmed. The test for confirming the presence or absence of an air was performed by visually counting the number of air bubbles in the sample of Example 11.

Test for Confirming Presence or Absence of Moiré

When the volumetric shrinkage of the resin layer disposed on the display surface of an image display unit and composed of a pressure-sensitive adhesive tape and a cured liquid adhesive is large, this sometimes causes deformation of the polarizing plate of the image display unit and allows generation of moiré in the image. Therefore, a test for confirming the presence or absence of moiré was performed so as to confirm that moiré is not generated. Each of the samples of Examples 12 and 13 and Comparative Examples 2 and 3 was put on the display surface of a liquid crystal image display device and after displaying an image on the display surface of the liquid crystal image display device, the presence or absence of the generation of moiré was confirmed by visual confirmation.

### Image Unevenness Test and Precision Test of Thickness Adjustment

When the resin layer disposed on the display surface of an image display unit and composed of a pressure-sensitive adhesive sheet and a cured liquid adhesive has a residual stress, the image displayed on the image display unit sometimes becomes uneven. Therefore, an image unevenness test was performed so as to confirm that image unevenness due to a residual stress is not produced. Also, for confirming that the resin layer composed of a pressure-sensitive adhesive sheet and a cured liquid adhesive can be controlled to have a desired thickness (for example, 175 μm), a precision test of thickness adjustment was performed, Furthermore, the presence or absence of an air bubble was confirmed.

Each of the samples of Examples 14 and 15 and Comparative Examples 4 and 5 was put on the display surface of a liquid crystal image display device and after displaying an image on the display surface of the liquid crystal image display device, the presence or absence of image unevenness was confirmed by visual observation. The thicknesses of the samples of Examples 14 and 15 and the thicknesses of the samples of Comparative Examples 4 and 5 were measured by a thickness meter, and the thickness of the resin layer (pressure-sensitive adhesive sheet and/or cured liquid adhesive) was calculated by subtracting the thickness of the transparent glass plate from the measured value above. Thereafter, whether the thickness of the resin layer fulfills the target thickness (175 μm) was confirmed. The presence or absence of an air bubble in the samples of Examples 14 and 15 and Comparative Examples 4 and 5 was confirmed by visual observation.

### Reworkability Test

Reworkability was examined by stripping the transparent glass plate from the sample of Example 3 before irradiating an ultraviolet ray and again adhering together the transparent glass plates. For comparison, a sample produced by adhering together a pair of transparent glass plates by using only a pressure-sensitive adhesive tape, and a sample produced by adhering together a pair of transparent glass plates by using only a liquid adhesive and not irradiating an ultraviolet ray, were also checked for the reworkability by stripping the transparent glass plate from the sample and again adhering together the transparent glass plates.

### D. Test Results

### Test for Confirming Presence or Absence of Air Bubble

The results are shown in Table 3. In Comparative Example 1, the number of air bubbles was excessively large, such that, the number of air bubbles could not be counted.

TABLE 3
Number of Air Bubbles Contained in Sample

| Sample | Number of Air Bubbles |
|---|---|
| Example 1 | 15 |
| Example 2 | 0 |
| Example 3 | 0 |
| Example 4 | 0 |
| Example 5 | 21 |
| Comparative Example 1 | unmeasurable |

### Test for Confirming Gap Due to Step Part

In Examples 6 to 10, the gap between the transparent glass plate and the pressure-sensitive adhesive sheet, which was generated due to a step part, was filled with a cured liquid adhesive.

### Test for Confirming Presence or Absence of Air Bubble in Use of Large Glass Plate

No air bubble was contained in the sample of Example 11.

Test for Confirming Presence or Absence of Moiré

The results are shown in Table 4. In Table 4, “A” indicates that moiré was not generated, and “C” indicates the level of generation of moiré was the level unsuitable for practical use.

TABLE 4
Generation of Moiré

| Sample | Generation of Moiré |
|---|---|
| Example 12 | A |
| Example 13 | A |
| Comparative Example 2 | A |
| Comparative Example 3 | C |

### Image Unevenness Test and Precision Test of Thickness Adjustment

The results are shown in Table 5. In Table 5, “A” in the item of image unevenness indicates that image unevenness was not generated, “B” indicates that the level of generation of image unevenness was the practically allowable level, and “C” indicates that the level of generation of image unevenness was the level unsuitable for practical use. In the item of precision of thickness adjustment, “A” indicates that the thickness of the resin layer was the target thickness, and “C” indicates that the thickness of the resin layer did not reach the target thickness. In the item of presence or absence of air bubbles, “A” indicates that an air bubble was not contained, and “C” indicates that a fairly large number of air bubbles were present.

TABLE 5
Image Unevenness, Precision of Thickness Adjustment and
Presence or Absence of Air Bubble

| | | Precision | Presence or |
|---|---|---|---|
| | Image | of Thickness | Absence |
| Sample | Unevenness | Adjustment | of Air Bubble |
| Example 14 | B | A | A |
| Example 15 | B | A | A |
| Comparative Example 4 | B | A | C |
| Comparative Example 5 | A | C | A |

### Reworkability Test

It was confirmed that, prior to curing the liquid adhesive, the transparent glass plates in the sample of Example 3 could be stripped from each other and again adhered together. In the sample produced by adhering together a pair of transparent glass plates only by a liquid adhesive, prior to curing the liquid adhesive, after stripping the glass plates from each other and removing the liquid adhesive, the transparent glass plates could be adhered together by again applying a liquid adhesive. However, in the sample produced by adhering together a pair of transparent glass plates only by a pressure-sensitive adhesive sheet, it was difficult to completely remove the pressure-sensitive adhesive sheet from the transparent glass sheet, and this was unsuitable for reworking.

The above-described embodiments can also be combined.

Although the present invention has been described with reference to preferred embodiments, workers skilled in the art will recognize that changes may be made in form and detail without departing from the spirit and scope of the invention

1. A method of manufacturing an image display device, comprising:
a step of providing a translucent sheet, a pressure-sensitive adhesive sheet, an image
display unit and a liquid adhesive,
wherein the translucent sheet has a first principal surface, a second principal surface opposite the first principal surface, a first edge part and a second edge part opposite the first edge part,
wherein the pressure-sensitive adhesive sheet has a first principal surface and a second principal surface opposite the first principal surface, and
wherein the image display unit has a display surface;
a step of laminating the first principal surface of the pressure-sensitive adhesive sheet to the first principal surface of the translucent sheet;
a step of applying the liquid adhesive to at least a part of at least one of the second principal surface of the pressure-sensitive adhesive sheet and the display surface of the image display unit;
a step of opposing the first principal surface of the translucent sheet to the display surface of the image display unit, comprising:
putting the first edge part of the translucent sheet close to the display surface of the image display unit until a portion of the pressure-sensitive adhesive sheet laminated to the translucent sheet in the vicinity of the first edge part of the translucent sheet comes into contact with the display surface of the image display unit, and
putting the second edge part of the translucent sheet close to the display surface of the image display unit while flowing the liquid adhesive in the direction of the second edge part from the first edge part of the translucent sheet, and thereby laminating the second principal surface of the pressure-sensitive adhesive sheet laminated with the translucent sheet to the display surface of the image display unit; and
a step of curing the liquid adhesive remaining between the second principal surface of the pressure-sensitive adhesive sheet laminated to the translucent sheet and the display surface of the image display unit.

2. The method of manufacturing an image display device as claimed in claim 1, wherein the display surface of the image display unit has a screen size of about 10 inches (254 mm) or more.

3. The method of manufacturing an image display device as claimed in claim 1, wherein a variation of distance between the first principal surface of the translucent sheet and the display surface of the image display unit after curing the liquid adhesive is about 5 μm or less.

4. The method of manufacturing an image display device as claimed in claim 1, wherein a thickness of the pressure-sensitive adhesive sheet is from about 25 to 300 μm, wherein the display surface of the image display unit has a step part, and wherein a height of the step part is about 15% or more of the thickness of the pressure-sensitive adhesive sheet.

5. The method of manufacturing an image display device as claimed in claim 1, wherein the step of laminating the second principal surface of the pressure-sensitive adhesive sheet laminated with the translucent sheet to the display surface of the image display unit comprises adding an external force having a component perpendicular to the display surface of the image display unit to the second principal surface of the translucent sheet and the position at which the external force is added to the second principal surface of the translucent sheet is moved in the direction of the second edge part from the first edge part of the translucent sheet.

6. The method of manufacturing an image display device as claimed in claim 1, wherein a viscosity of the liquid adhesive is from about 10 to 4,000 mPa·s.

7. The method of manufacturing an image display device as claimed in claim 1, wherein the pressure-sensitive adhesive sheet contains an acrylic copolymerized polymer and the liquid adhesive contains an acrylic monomer, and wherein the liquid adhesive after curing has a refractive index between the refractive index of the pressure-sensitive adhesive sheet and the refractive index of the display surface of the image display unit.

8. The method of manufacturing an image display device as claimed in claim 1, wherein an adhesive force between the liquid adhesive after curing and the pressure-sensitive adhesive sheet is about 1 N/25 mm or more.
